(19) United States
(12) Patent Application Publication
(10) Pub. No.: US 2026/0173048 A1
(43) Pub. Date: Jun. 18, 2026

(54) MULTIPLE SUBSCRIBER IDENTITY MODULE (MSIM) WITH CARRIER AGGREGATION (CA) IN A DOWNLINK PIPE LIMITED TRANSCEIVER

(71) Applicant: QUALCOMM Incorporated, San Diego, CA (US)

(72) Inventors: Saranyan NAGARAJAN, Hyderabad (IN); Srinivas PACHAVA, Hyderabad (IN); Raveesh JUNEJA, Hyderabad (IN); Yung-Yih JIAN, Campbell, CA (US); Parthiban RAJENDRAN, Hyderabad (IN); Ehab ABDEL GHANY, San Diego, CA (US); Mahim RANJAN, San Diego, CA (US); Sree Venkatesh THATAVARTHY, Bangalore (IN); Sriramgopal SRIDHARA, San Diego, CA (US)

(21) Appl. No.: 18/982,436

(22) Filed: Dec. 16, 2024

(51) Int. Cl. H04W 72/0453; H04L 1/00; H04W 72/542

(52) U.S. Cl. CPC H04W 72/0453; H04L 1/0003; H04W 72/542

(57) ABSTRACT

A system includes a first frequency synthesizer configured to generate a first local oscillator (LO) signal and a second frequency synthesizer configured to generate a second LO signal. The system also includes a first receive circuit configured to receive a first carrier and a second carrier for a first subscriber and mix the first carrier and the second carrier with the first LO signal or the second LO signal. The system also includes a second receive circuit configured to receive a third carrier for a second subscriber and mix the third carrier with the first LO signal or the second LO signal. The system further includes a first multiplexer configured to selectively couple the first LO signal or the second LO signal to the first receive circuit and a second multiplexer configured to selectively couple the first LO signal or the second LO signal to the second receive circuit.

### BACKGROUND

### Field

Aspects of the present disclosure relate generally to wireless communications, and, more particularly, to multiple subscriber identity module (MSIM) with carrier aggregation (CA).

### BACKGROUND

A wireless device may include one or more transceivers and multiple antennas for transmitting and/or receiving radio frequency (RF) signals. The wireless device may include multiple subscriber identity modules (SIMs) where each SIM is associated with a different subscriber. The wireless device may also use carrier aggregation to receive data and/or control information in which two or more carriers (also referred to as component carriers) are aggregated (e.g., to increase data throughput).

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to system for wireless communications. The system includes a first frequency synthesizer configured to generate a first local oscillator (LO) signal and a second frequency synthesizer configured to generate a second LO signal. The system also includes a first receive circuit configured to receive a first carrier and a second carrier for a first subscriber and mix the first carrier and the second carrier with the first LO signal or the second LO signal to generate a first downconverted signal and a second downconverted signal. The system also includes a second receive circuit configured to receive a third carrier for a second subscriber and mix the third carrier with the first LO signal or the second LO signal to generate a third downconverted signal. The system further includes a first multiplexer configured to selectively couple the first LO signal or the second LO signal to the first receive circuit and a second multiplexer configured to selectively couple the first LO signal or the second LO signal to the second receive circuit.

A second aspect relates to a method for wireless communications. The method includes generating a first local oscillator (LO) signal using a first frequency synthesizer, generating a second LO signal using a second frequency synthesizer, receiving a first carrier and a second carrier for a first subscriber, and receiving a third carrier for a second subscriber. The method also includes, in a first configuration, mixing the first carrier and the second carrier with the first LO signal to generate a first downconverted signal and a second downconverted signal and mixing the third carrier with the second LO signal to generate a third downconverted signal. The method also includes, in a second configuration, mixing the first carrier and the second carrier with the second LO signal to generate the first downconverted signal and the second downconverted signal and mixing the third carrier with the first LO signal to generate the third downconverted signal.

### BRIEF DESCRIPTION OF THE DRAWINGS

FIG. 1 is a diagram of an environment including a first base station, a second base station, and a wireless device that includes a transceiver according to certain aspects of the present disclosure.

FIG. 2 shows an exemplary implementation of the wireless device of FIG. 1 according to certain aspects of the present disclosure.

FIG. 3 shows an example of a transceiver capable of operating in different configurations according to certain aspects of the present disclosure.

FIG. 4A shows an example of non-contiguous carrier aggregation in which separate local oscillator (LO) signals are used to frequency downconvert a first carrier and a second carrier according to certain aspects of the present disclosure.

FIG. 4B shows an example of non-contiguous carrier aggregation in which the same LO signal is used to frequency downconvert the first carrier and the second carrier according to certain aspects of the present disclosure.

FIG. 4C shows an example of contiguous carrier aggregation in which the same LO signal is used to frequency downconvert the first carrier and the second carrier according to certain aspects of the present disclosure.

FIG. 5A shows an example in which the transceiver of FIG. 3 is configured to provide MSIM with non-contiguous CA according to certain aspects of the present disclosure.

FIG. 5B shows another example in which the transceiver of FIG. 3 is configured to provide MSIM with non-contiguous CA according to certain aspects of the present disclosure.

FIG. 6A shows an example in which the transceiver of FIG. 3 is configured to provide MSIM with contiguous CA according to certain aspects of the present disclosure.

FIG. 6B shows another example in which the transceiver of FIG. 3 is configured to provide MSIM with contiguous CA according to certain aspects of the present disclosure.

FIG. 7 shows an exemplary table of modulation coding scheme (MCS) thresholds for entering and exiting a low power mode according to certain aspects of the present disclosure.

FIG. 8A illustrates a full grant for both a first carrier and a second carrier according to certain aspects of the present disclosure.

FIG. 8B illustrates a scenario in which physical downlink shared channel (PDSCH) modulation coding schemes (MCSs) for the first carrier and the second carrier are below a MCS threshold according to certain aspects of the present disclosure.

FIG. 8C illustrates a scenario in which the PDSCH MCS for the first carrier is below the MCS threshold and the second carrier is in physical downlink control channel (PDCCH) only traffic according to certain aspects of the present disclosure.

FIG. 8D illustrates a scenario in which both the first carrier and the second carrier are in PDCCH only traffic according to certain aspects of the present disclosure.

FIG. 9A illustrates a full grant for both the first carrier and the second carrier according to certain aspects of the present disclosure.

FIG. 9B illustrates a scenario in which the grant for the second carrier is reduced according to certain aspects of the present disclosure.

FIG. 9C illustrates a scenario in which the network reallocates the grant for the second carrier to the first carrier according to certain aspects of the present disclosure.

FIG. 9D illustrates a scenario in which the second carrier is deactivated according to certain aspects of the present disclosure.

FIG. 9E illustrates a scenario in which the grant for the first carrier is reduced according to certain aspects of the present disclosure.

FIG. 9F illustrates a scenario in which the first carrier is in PDCCH only traffic according to certain aspects of the present disclosure.

FIG. 10 shows an example of a transceiver configured to support a dual SIM dual active (DSDA) mode according to certain aspects of the present disclosure.

FIG. 11 shows an example in which the transceiver of FIG. 10 further includes a cross switch according to certain aspects of the present disclosure.

FIG. 12 is a flowchart illustrating a method for subscriber switching according to certain aspects of the present disclosure.

FIG. 13 is a flowchart illustrating a method for wireless communications according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

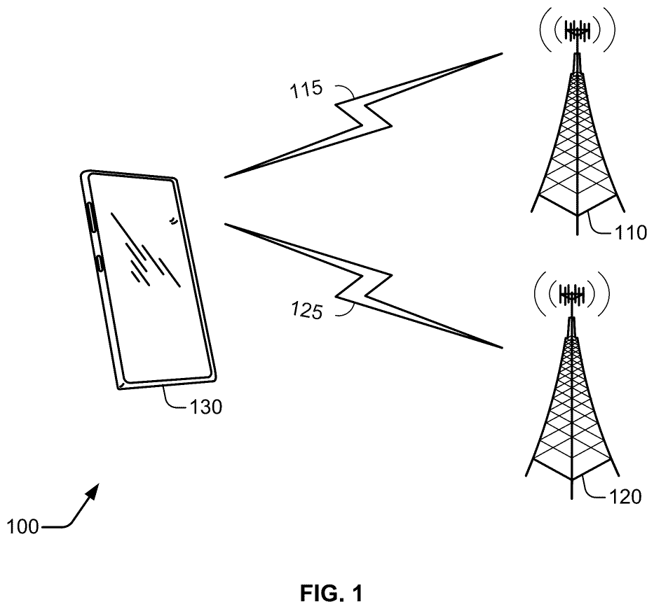

FIG. 1 is a diagram of an environment 100 that includes a wireless device 130, a first base station 110, and a second base station 120. Each of the base stations 110 and 120 may include or may be referred to as an access point, a NodeB, a next-generation Node B (also referred to as a gNB or gNodeB), a Home NodeB (also referred to as HNB), or some other terminology. The wireless device 130 may also be referred to as a mobile device, a remote device, user equipment (UE), a handheld device, or some other terminology. The wireless device 130 may include a cellular phone (e.g., smartphone), a gaming device, a navigation device, a smart appliance, an Internet of Things (IoT) device, a tablet computer, an asset tracker, a sensor or security device, a laptop computer, a wearable device (e.g., a smartwatch, a fitness tacker, etc.), or the like.

In the environment 100, the wireless device 130 may communicate with the first base station 110 via a first wireless link 115, which may include a downlink of data and/or control information transmitted from the first base station 110 to the wireless device 130 and an uplink of other data and/or control information transmitted from the wireless device 130 to the first base station 110. The wireless device 130 may also communicate with the second base station 120 via a second wireless link 125, which may include a downlink of data and/or control information transmitted from the second base station 120 to the wireless device 130 and an uplink of other data and/or control information transmitted from the wireless device 130 to the second base station 120. Each of the wireless links 115 and 125 may be implemented using any suitable communication protocol or standard, such as 3rd Generation Partnership Project Long-Term Evolution (3GPP LTE, 3GPP NR 5G), IEEE 1302.13, IEEE 1302.13, Bluetooth™, and so forth.

In certain aspects, the wireless device 130 may be a multi-subscriber identity module (multi-SIM) wireless device that supports communication using multiple SIMs where each SIM may be associated with a different subscriber. In these aspects, the wireless device 130 may communicate with the first base station 110 using a first SIM associated with a first subscriber and communicate with the second base station 120 using a second SIM associated with a second subscriber, as discussed further below. In these aspects, the first base station 110 and the second base station 120 may be associated with different carrier networks or the same carrier network.

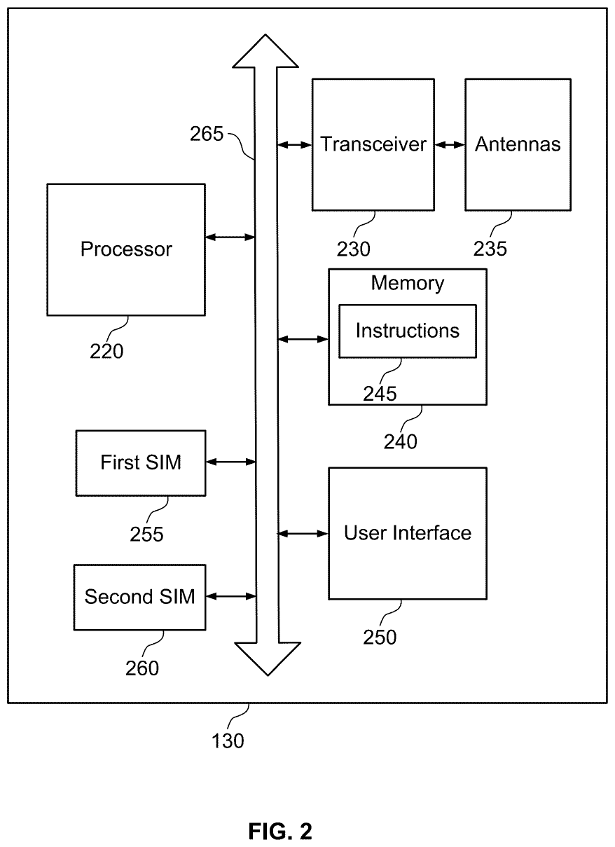

FIG. 2 is a block diagram showing an exemplary implementation of the wireless device 130 according to aspects of the present disclosure. In this example, the wireless device 130 includes a processor 220, a memory 240, a transceiver 230, antennas 235, a user interface 250, a first SIM 255, and a second SIM 260. These components may be in electronic communication via one or more buses 265.

The memory 240 may store instructions 245 that are executable by the processor 220 to cause the wireless device 130 to perform one or more of the operations described herein. The processor 220 may include a general-purpose processor, a modem, a baseband processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or any combination thereof. The memory 240 may include, by way of example, random access memory (RAM), flash memory, read only memory (ROM), programmable read only memory (PROM), erasable programmable read only memory (EPROM), electrically erasable programmable read only memory (EEPROM), registers, magnetic disks, optical disks, hard drives, or any other suitable storage medium, or any combination thereof.

The transceiver 230 is configured to communicate with base stations (e.g., the first base station 110 and the second base station 120) via the antennas 235. More particularly, the transceiver 230 is configured to transmit signals to the base stations and receive signals from the base stations via the antennas 235, as discussed further below.

The user interface 250 may be configured to receive data from a user (e.g., via keypad, mouse, touchscreen, etc.) and provide the data to the processor 220. The user interface 250 may also be configured to output data from the processor 220 to the user (e.g., via a display, a speaker, etc.).

In certain aspects, the first SIM 255 includes memory (e.g., in a removable integrated circuit card) that stores an international mobile subscriber identity (IMSI), user account information, authentication information, and/or other information used to identify and/or authenticate a first subscriber with a network. The first subscriber may have a subscription for one or more services (e.g., data services, voice services, IMS services, etc.) on the network. In one example, the wireless device 130 transmits the IMSI and the authentication information for the first subscriber to the first base station 110 to access the network (e.g., carrier network) via the first base station 110 as the first subscriber.

The second SIM 260 includes memory (e.g., in a removable integrated circuit card) that stores an IMSI, user account information, authentication information, and/or other information used to identify and/or authenticate a second subscriber with the same network as the first SIM 255 or a different network. The second subscriber may have a subscription for one or more services (e.g., data services, voice services, IMS services, etc.) on the network. In one example, the wireless device 130 transmits the IMSI and the authentication information for the second subscriber to the second base station 120 to access the network (e.g., carrier network) via the second base station 120 as the second subscriber. In another example, the wireless device 130 transmits the IMSI and the authentication information for the second subscriber to the first base station 110 to access the network (e.g., carrier network) via the first base station 110 as the second subscriber (e.g., for the case where the first subscriber and the second subscriber have subscriptions with the same carrier network).

The first and second subscribers may have subscriptions with the same carrier network or different carrier networks. Also, the first and second subscribers may have subscriptions for the same services and/or different services.

The wireless device 130 may support one or more modes of operations for multiple subscribers. For example, the wireless device 130 may support a dual SIM dual standby (DSDS) mode, in which one of the subscribers may actively receive and transmit signals via the transceiver 230 at a time while the other subscriber may be put on standby. In another example, the wireless device 130 may support a dual SIM dual active (DSDA) mode, in which both subscribers may actively receive and transmit signals via the transceiver 230 at the same time. It is to be appreciated that the present disclosure is not limited to the above examples.

The transceiver 230 may include multiple transceivers to support multiple subscribers. However, as discussed further below, it is desirable to share one or more transceivers among multiple subscribers (e.g., the first subscriber and the second subscriber) to reduce area and cost.

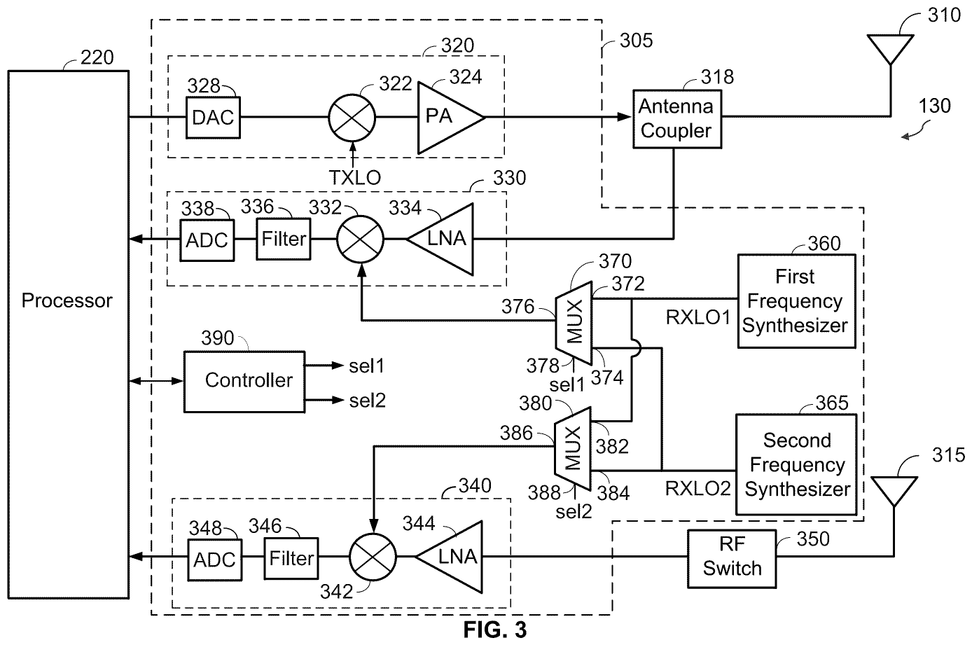

FIG. 3 shows an example of a transceiver 305 according to certain aspects. The transceiver 305 may be included in the transceiver 230 shown in FIG. 2. As discussed further below, the transceiver 305 may operate in any one of multiple configurations. The configurations may include one or more configurations that allow the first subscriber and the second subscriber to share the transceiver 305 (e.g., in the DSDS mode) and/or allow the first subscriber and/or the second subscriber to receive RF signals using carrier aggregation (e.g., for increased throughput).

In the example shown in FIG. 3, the antennas 235 in FIG. 2 include a first antenna 310 and a second antenna 315. The first antenna 310 and the second antenna 315 may be physically spaced apart on the wireless device 130. The first antenna 310 and the second antenna 315 may be orientated in different directions or the same direction.

The transceiver 305 also includes a transmit circuit 320, a first receive circuit 330, and a second receive circuit 340. In this example, the transmit circuit 320 and the first receive circuit 330 are coupled to the first antenna 310 via an antenna coupler 318. The antenna coupler 318 may include a duplexer, a diplexer, switches, or another type of antenna coupler configured to couple a transmit circuit and a receive circuit to a shared antenna. The second receive circuit 340 may be coupled to the second antenna 315 through an RF switch 350 that allows the second antenna 315 to be selectively coupled to the second receive circuit 340. The RF switch 350 may also allow the second antenna 315 to be selectively coupled to one or more other receive circuits and/or transmitters (not shown).

In the example shown in FIG. 3, the transmit circuit 320 is coupled between the processor 220 and the antenna coupler 318 (e.g., duplexer), and the first receive circuit 330 is coupled between the processor 220 and the antenna coupler 318. The second receive circuit 340 is coupled between the second antenna 315 and the processor 220 (e.g., through the RF switch 350). In this example, the processor 220 may include a baseband processor and/or a radio defined software.

In this example, the transmit circuit 320 includes a digital-to-analog converter (DAC) 328, a transmit mixer 322, and a power amplifier 324. The DAC 328 may be configured to convert a digital baseband signal from the processor 220 into an analog baseband signal. The transmit mixer 322 may be configured to mix the baseband from the DAC 328 with a transmit local oscillator (TXLO) signal to frequency upconvert the baseband signal into a transmit radio frequency (RF) signal. The power amplifier 324 is configured to amplify the transmit RF signal, and output the amplified RF signal to the antenna coupler 318 (e.g., duplexer) for transmission via the first antenna 310. It is to be appreciated that the transmit circuit 320 may include one or more additional components not shown in FIG. 3. For example, in some implementations, the transmit circuit 320 may include another mixer (not shown) preceding the transmit mixer 322 for frequency upconverting the baseband signal from the DAC 328 into an intermediate frequency (IF) signal. In this example, the transmit mixer 322 mixes the IF signal with the TXLO signal to frequency upconvert the IF signal into the transmit RF signal.

In some implementations, the transmit mixer 322 and the power amplifier 324 are integrated on the same chip. In other implementations, the mixer 322 is integrated on a chip and the power amplifier 324 is an off-chip (i.e., external) component. In these implementations, the chip may include a driver (not shown) between the mixer 322 and the power amplifier 324 for driving the power amplifier 324 with the RF signal.

In the example shown in FIG. 3, the first receive circuit 330 includes a first low-noise amplifier 334, a first receive mixer 332, a first filter 336, and a first analog-to-digital converter (ADC) 338. The first low-noise amplifier 334 is configured to receive an RF signal from the first antenna 310 via the antenna coupler 318, amplify the received RF signal, and output the amplified RF signal to the first receive mixer 332. The first receive mixer 332 is configured to mix the amplified RF signal with a local oscillator signal to frequency downconvert the amplified RF signal into a baseband signal or an IF signal. For the example where the first receive mixer 332 converts the amplified RF signal into the IF signal, the first receive circuit 330 may include another mixer (not shown) after the first receive mixer 332 for frequency downconverting the IF signal into the baseband signal. The first filter 336 may be configured to pass the baseband signal and filter out out-of-band signals. The first filter 336 may be omitted in some implementations. The first ADC 338 may be configured to convert the baseband signal into a digital baseband signal and output the digital baseband signal to the processor 220 for further processing (e.g., demodulation, decoding, etc.) in the digital domain.

In some implementations, the first receive mixer 332 and the first low-noise amplifier 334 are integrated on the same chip. In other implementations, the first receive mixer 332 is integrated on a chip and the first low-noise amplifier 334 is an off-chip (i.e., external) component. In these implementations, the chip may include an amplifier (not shown) between the first low-noise amplifier 334 and the first receive mixer 332.

In the example shown in FIG. 2, the second receive circuit 340 includes a second low-noise amplifier 344, a second receive mixer 342, a second filter 346, and a second ADC 348. The second low-noise amplifier 344 is configured to receive an RF signal from the second antenna 315, amplify the received RF signal, and output the amplified RF signal to the second receive mixer 342. The second receive mixer 342 may be configured to mix the amplified RF signal with a local oscillator signal to frequency downconvert the amplified RF signal into a baseband signal or an IF signal. The local oscillator signal input to the second receive mixer 342 may be the same as the local oscillator signal input to the first receive mixer 332 or different from the local oscillator signal input to the first receive mixer 332 (e.g., depending on the configuration of the transceiver 305). For the example where the second receive mixer 342 converts the amplified RF signal into the IF signal, the second receive circuit 340 may include another mixer (not shown) after the second receive mixer 342 for frequency downconverting the IF signal into the baseband signal. The second filter 346 may be configured to pass the baseband signal and filter out out-of-band signals. The second filter 346 may be omitted in some implementations. The second ADC 348 may be configured to convert the baseband signal into a digital baseband signal and output the digital baseband signal to the processor 220 for further processing (e.g., demodulation, decoding, etc.) in the digital domain.

In some implementations, the second receive mixer 342 and the second low-noise amplifier 344 are integrated on the same chip. In other implementations, the second receive mixer 342 is integrated on a chip and the second low-noise amplifier 344 is an off-chip (i.e., external) component. In these implementations, the chip may include an amplifier (not shown) between the second low-noise amplifier 344 and the second receive mixer 342.

It is to be appreciated that, in some implementations, each of the mixers 322, 332, and 342 shown in FIG. 3 may be implemented with an in-phase/quadrature (I/Q) mixer. For example, the first receive mixer 332 may be implemented with an I/Q mixer including a first mixer that mixes the respective RF signal with a local oscillator signal to generate an in-phase baseband or IF signal, and a second mixer that mixes the respective RF signal with the local oscillator signal shifted by 90 degrees to generate a quadrature baseband or IF signal. In this example, the respective baseband includes an in-phase (I) baseband signal and a quadrature (Q) baseband signal. The second receive mixer 342 may also be implemented with an I/Q mixer in a similar manner. However, it is to be appreciated that the present disclosure is not limited to this example.

In this example, the transceiver 305 also includes a first frequency synthesizer 360 and a second frequency synthesizer 365. The first frequency synthesizer 360 is configured to generate a first receive local oscillator (RXLO1) signal, and the second frequency synthesizer 365 is configured to generate a second receive local oscillator (RXLO2) signal. The first frequency synthesizer 360 and the second frequency synthesizer 365 may each be implemented with a phase-locked loop (PLL), an inductor-capacitor (LC) oscillator, a ring oscillator, or the like.

The RXLO1 signal and the RXLO2 signal may have the same frequency or different frequencies (e.g., depending on the configuration of the transceiver 305). In certain aspects, the frequency of the first frequency synthesizer 360 may be tunable to tune the frequency of the RXLO1 signal. The frequency of the first frequency synthesizer 360 may be continuously tunable within one or more frequency ranges and/or the frequency of the first frequency synthesizer 360 may be switched to any one of multiple frequencies. The frequency of the second frequency synthesizer 365 may be also tunable to tune to frequency of the RXLO2 signal. The frequency of the second frequency synthesizer 365 may be continuously tunable within one or more frequency ranges and/or the frequency of the second frequency synthesizer 365 may be switched to any one of multiple frequencies.

In certain aspects, the first frequency synthesizer 360 may be configured to provide higher performance than the second frequency synthesizer 365 while the second frequency synthesizer 365 is configured to consume less power than the first frequency synthesizer 360. In these aspects, the first frequency synthesizer 360 may also be referred to as a high-performance mode (HPM) frequency synthesizer and the second frequency synthesizer 365 may also be referred to as a low power mode (LPM) frequency synthesizer. As discussed further below, the first frequency synthesizer 360 and the second frequency synthesizer 365 allow the transceiver 305 to opportunistically lower power by switching from the first frequency synthesizer 360 to the second frequency synthesizer 365 in cases where the second frequency synthesizer 365 provides sufficient performance to reliably receive an RF signal.

For example, the first frequency synthesizer 360 may include an inductor-capacitor (LC) oscillator and the second frequency synthesizer 365 may include a ring oscillator. In this example, the ring oscillator consumes less power than the LC oscillator while the LC oscillator provides better noise performance than the ring oscillator. Thus, in this example, the LC oscillator and the ring oscillator provide a tradeoff between power consumption and noise performance. In this example, the frequency of the RXLO1 signal may be tuned, for example, by tuning a capacitance of the capacitor of the LC oscillator. The frequency of the RXLO2 signal may be tuned, for example, by tuning the drive strength of inverters in the ring oscillator.

In this example, the RXLO1 signal refers to the LO signal generated by the HPM frequency synthesizer (e.g., the first frequency synthesizer 360) for the HPM, and the RXLO2 signal refers to the LO signal generated by the LPM frequency synthesizer (e.g., the second frequency synthesizer 365) for the LPM. It is to be understood that the RXLO1 signal and the RXLO2 signal do not refer to two different absolute LO frequencies. As discussed further below, the RXLO1 signal may be switched between the first subscriber and the second subscriber and the frequency of the RXLO1 signal may be tuned, for example, depending on whether the RXLO1 signal is currently being used for the first subscriber or the second subscriber. Also, the RXLO2 signal may be switched between the first subscriber and the second subscriber and the frequency of the RXLO2 signal may be tuned, for example, depending on whether the RXLO2 signal is currently being used for the first subscriber or the second subscriber.

In this example, the transceiver 305 also includes a first multiplexer 370 and a second multiplexer 380. The first multiplexer 370 is configured to selectively couple the RXLO1 signal or the RXLO2 to the first receive mixer 332, and the second multiplexer 380 is configured to selectively couple the RXLO1 signal or the RXLO2 to the second receive mixer 342. Each of the multiplexers 370 and 380 may be implemented with switches, logic gates, or any combination thereof.

In the example shown in FIG. 3, the first multiplexer 370 has a first input 372, a second input 374, and an output 376. The first input 372 is coupled to the first frequency synthesizer 360 to receive the RXLO1 signal, the second input 374 is coupled to the second frequency synthesizer 365 to receive the RXLO2 signal, and the output 376 is coupled to the first receive mixer 332. The first multiplexer 430 is configured to receive a first select signal (labeled “sel1”) at select input 378 and selectively couple the RXLO1 signal or the RXLO2 to the first receive mixer 332 based on the first select signal. For example, the first multiplexer 370 may select the RXLO1 signal when the first select signal has a first logic value and select the RXLO2 signal when the first select signal has a second logic value. The first logic value may be one and the second logic value may be zero, or vice versa.

The second multiplexer 380 has a first input 382, a second input 384, and an output 386. The first input 382 is coupled to the first frequency synthesizer 360 to receive the RXLO1 signal, the second input 384 is coupled to the second frequency synthesizer 365 to receive the RXLO2 signal, and the output 386 is coupled to the second receive mixer 342. The second multiplexer 380 is configured to receive a second select signal (labeled “sel2”) at select input 388 and selectively couple the RXLO1 signal or the RXLO2 to the second receive mixer 342 based on the second select signal. For example, the second multiplexer 380 may select the RXLO1 signal when the second select signal has the first logic value and select the RXLO2 signal when the second select signal has the second logic value, or vice versa.

In this example, the transceiver 305 includes a controller 390 for generating the first select signal and the second select signal. The individual connections between the controller 390 and the multiplexers 370 and 380 are not explicitly shown in FIG. 3 for ease of illustration. The controller 390 may configure the transceiver 305 to operate in different configurations by controlling the selections of the multiplexers 370 and 380 using the first and second select signals. Exemplary configurations that may be supported by the transceiver 305 are discussed further below.

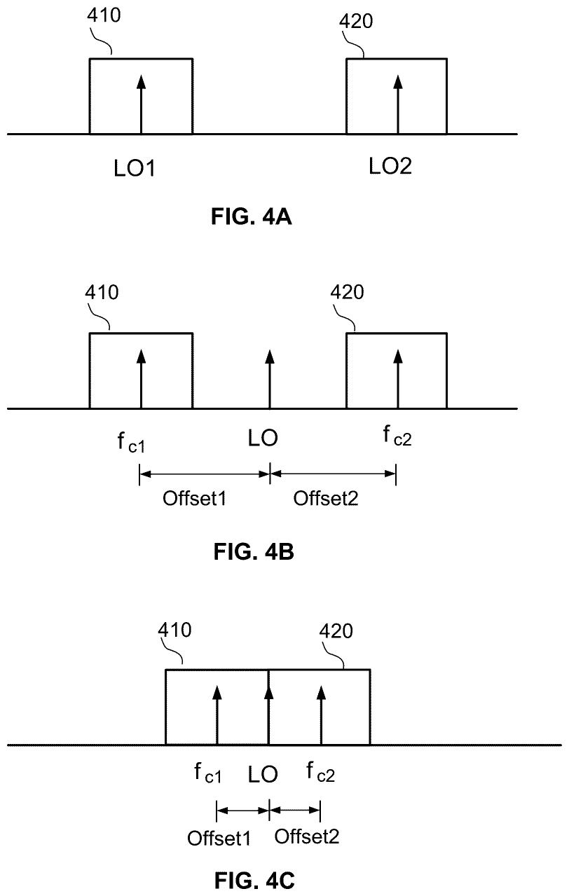

In a first configuration, the controller 390 causes the first multiplexer 370 to select the RXLO1 signal and the second multiplexer 380 to select the RXLO2 signal. Thus, in the first configuration, the first receive mixer 332 in the first receive circuit 330 uses the RXLO1 signal for frequency downconversion, and the second receive mixer 342 in the second receive circuit 340 uses the RXLO2 for frequency downconversion. In the first configuration, the controller 390 may also tune the frequency of the first frequency synthesizer 360 to locate the RXLO1 signal between the center frequency of a first carrier 410 and the center frequency 420 of a second carrier in the frequency domain. The carriers 410 and 420 are discussed further below with reference to FIGS. 4A to 4C. The controller 390 may also tune the frequency of the second frequency synthesizer 365 to locate the RXLO2 signal at the center frequency of the RF signal for the second subscriber in the frequency domain.

In a second configuration, the controller 390 causes the first multiplexer 370 to select the RXLO2 signal and the second multiplexer 380 to select the RXLO1 signal. Thus, in the second configuration, the first receive mixer 332 in the first receive circuit 330 uses the RXLO2 signal for frequency downconversion, and the second receive mixer 342 in the second receive circuit 340 uses the RXLO1 for frequency downconversion. In the second configuration, the controller 390 may also tune the frequency of the second frequency synthesizer 365 to locate the RXLO2 signal between the center frequency of the first carrier 410 and the center frequency 420 of the second carrier in the frequency domain. The controller 390 may also tune the frequency of the first frequency synthesizer 360 to locate the RXLO1 signal at the center frequency of the RF signal for the second subscriber in the frequency domain.

In both the first configuration and the second configuration, the transceiver 305 may actively receive and/or transmit RF signals for the first subscriber using the transmit circuit 320 and the first receive circuit 330 while receiving an RF signal for the second subscriber using the second circuit 340 (e.g., in the DSDS mode). For example, the transceiver 305 may actively receive and/or transmit the RF signals for the first subscriber using the transmit circuit 320 and the first receive circuit 330 to support a voice call for the first subscriber and/or a data transfer for the first subscriber. In this example, the first receive circuit 330 uses the RXLO1 signal for frequency downconversion in the first configuration and uses the RXLO2 signal for frequency downconversion in the second configuration.

The transceiver 305 also receives the RF signal for the second subscriber using the second receive circuit 340. For example, the RF signal for the second subscriber may include data and/or control information for the second subscriber such as, for example, paging information indicating that the second subscriber has a text message, an alert, and/or an incoming call. In this example, the processor 220 may determine the second subscriber has a text message, an alert, and/or an incoming call based on the paging information, and notify the user of the text message, alert, and/or the incoming call via the user interface 250 (shown in FIG. 2). This allows the second subscriber to be paged (i.e., receive paging information) while the transceiver 305 actively transmits and/or receives the RF signals for the first subscriber. In this example, the second receive circuit 340 uses the RXLO2 signal for frequency downconversion in the first configuration and uses the RXLO1 signal for frequency downconversion in the second configuration.

The wireless device 130 may also use carrier aggregation to receive data and/or control information in which two or more carriers (also referred to as component carriers) are aggregated to increase throughput. In this regard, FIG. 4A shows a frequency plot illustrating an example of carrier aggregation (CA) according to certain aspects. In this example, an RF signal includes the first carrier 410 and the second carrier 420 which are spaced apart from one another. The first carrier 410 may also be referred to as the first component carrier and the second carrier 420 may also be referred to as the second component carrier.

In some implementations, the first carrier 410 may be a primary component carrier (PCC) and the second carrier 420 may be a secondary component carrier (SCC). For example, a base station (e.g., base station 110 or 120) may assign the wireless device 130 a component carrier when a call and/or data session is first established. When the wireless device 130 receives a higher grant resulting in a higher throughput in the downlink, the base station may add the SCC to handle the higher throughout. When the SCC is added, the component carrier on which the call and/or data session was first established is called the PCC. The SCC may be a channel within the same band as the PCC or another band. However, it is to be appreciated that the present disclosure is not limited to this example.

FIG. 4A shows an example of non-contiguous CA in which the first carrier 410 and the second carrier 420 are spaced apart in frequency. The first carrier 410 and the second carrier 420 may be received at the wireless device 130 using two RF receive circuits where one of the RF receive circuits includes a first mixer and the other one of the RF receive circuits includes a second mixer. In this example, the first carrier 410 is frequency downconverted by the first mixer using a first local oscillator (LO1) signal and the second carrier 420 is frequency downconverted by the second mixer using a second oscillator (LO2) signal. However, using two LO signals (i.e., LO1 and LO2) to frequency downconvert the first carrier 410 and the second carrier 420 may increase area and power.

In this regard, FIG. 4B shows an example in which the first carrier 410 and the second carrier 420 are frequency downconverted using a single LO signal (e.g., to reduce area and power). In this example, the frequency of the LO signal is located between the center frequency f_{c1} of the first carrier 410 and the center frequency f_{c2} of the second carrier 420 in the frequency domain, in which the center frequency f_{c1} of the first carrier 410 and the LO signal are spaced apart by a first offset LO signal (labeled “Offset1” in FIG. 4B) and the center frequency f_{c2} of the second carrier 420 and the LO signal are spaced apart by a second offset (labeled “Offset2” in FIG. 4B). In certain aspects, the LO signal may be centered between the first carrier 410 and the second carrier 420, in which the first offset and the second offset are approximately equal. The first offset and the second offset may be very small compared with the frequencies of incoming RF signals.

In this example, the first carrier 410 and the second carrier 420 are mixed with the LO signal to frequency downconvert the first carrier 410 into a first downconverted signal and frequency downconvert the second carrier 420 into a second downconverted signal. In this example, the center frequency of the first downconverted signal is offset from zero frequency by the first offset and the center frequency of the second downconverted is offset from zero frequency by the second offset.

In this example, the first downconverted signal and the second downconverted may be converted into a digital signal for processing by the processor 220 in the digital domain. In this example, the processor 220 may shift the frequency of the first downconverted signal by the first offset in the digital domain to obtain a first digital baseband signal. The processor 220 may also shift the frequency of the second downconverted signal by the second offset (which may be equal to the first offset) in the digital domain to obtain a second digital baseband signal. Thus, the processor 220 may remove the first offset and the second offset in the digital domain. The processor 220 may then process the digital baseband signals (e.g., demodulation, decoding, etc.) to recover data and/or control information from the digital baseband signals.

FIG. 4C shows an example of contiguous CA in which the first carrier 410 and the second carrier 420 are next to one another. In this example, the first carrier 410 and the second carrier may also be frequency downconverted using the LO signal. In the example shown in FIG. 4C, the LO signal is located between the first carrier 410 and the second carrier 420. The first offset and the second offset in FIG. 4C are smaller than the first offset and the second offset in FIG. 4B since the first carrier 410 and the second carrier 420 are next to one another in FIG. 4C.

In this example, the first carrier 410 and the second carrier 420 are mixed with the LO signal to frequency downconvert the first carrier 410 into the first downconverted signal and frequency downconvert the second carrier 420 into the second downconverted signal. The first downconverted signal and the second downconverted signal may be converted into a digital signal for processing by the processor 220 in the digital domain. In this example, the processor 220 may shift the frequency of the first downconverted signal by the first offset in the digital domain to obtain the first digital baseband signal. The processor 220 may also shift the frequency of the second downconverted signal by the second offset (which may be equal to the first offset) in the digital domain to obtain the second digital baseband signal. The processor 220 may then process the digital baseband signals (e.g., demodulation, decoding, etc.) to recover data and/or control information from the digital baseband signals.

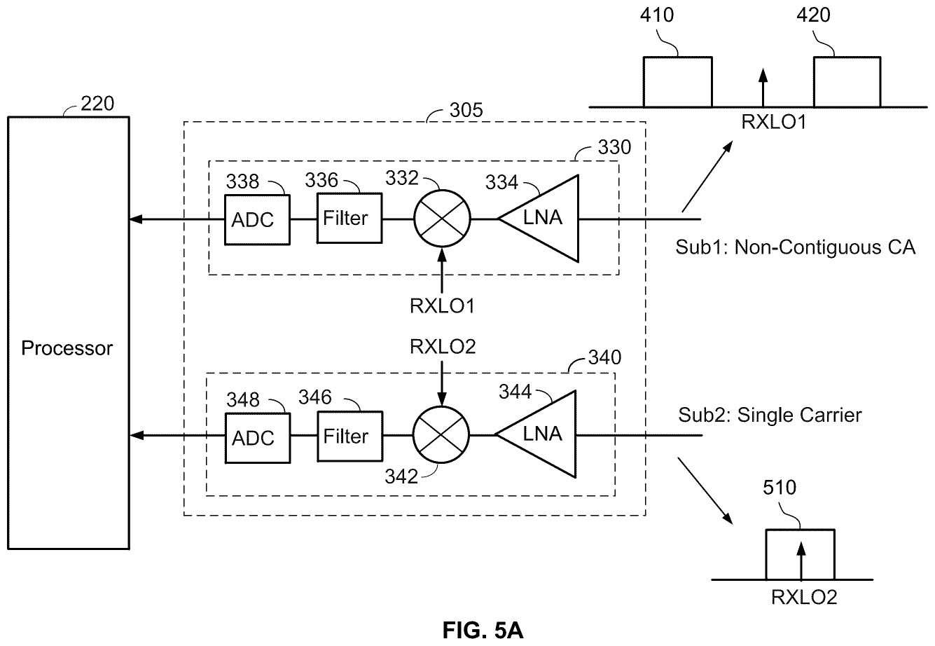

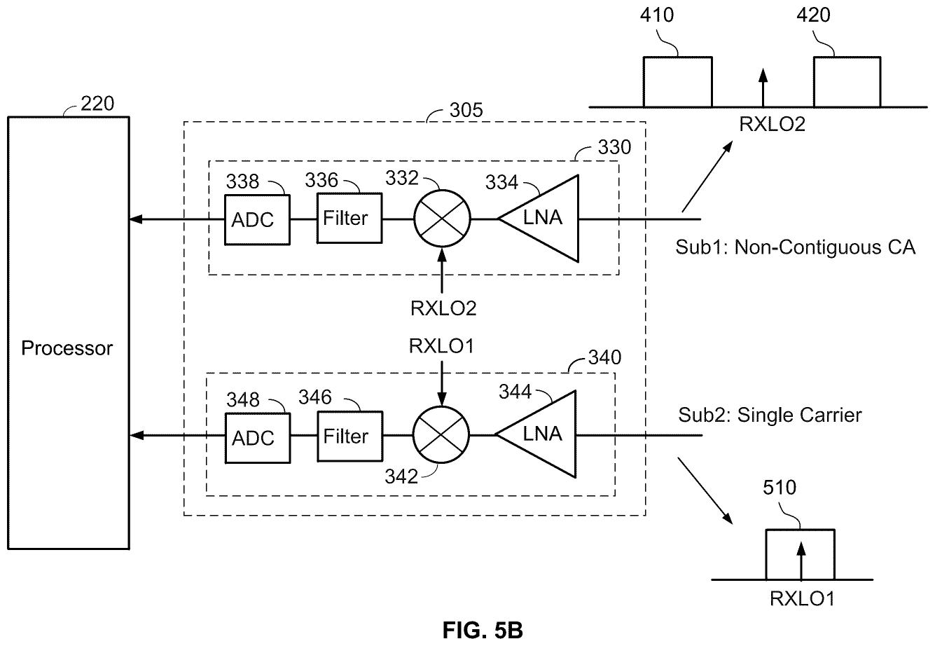

FIG. 5A illustrates an example in which the transceiver 305 provides MSIM with non-contiguous CA in the first configuration. As discussed above, in the first configuration, the RXLO1 signal from the first frequency synthesizer 360 (shown in FIG. 3) is input to the first receive mixer 332 and the RXLO2 signal from the second frequency synthesizer 365 (shown in FIG. 3) is input to the second receive mixer 334.

In this example, the transceiver 305 may actively receive and/or transmit RF signals for the first subscriber using the transmit circuit 320 (shown in FIG. 3) and the first receive circuit 330 while receiving an RF signal for the second subscriber using the second circuit 340 (e.g., in the DSDS mode). For example, the transceiver 305 may actively receive and/or transmit the RF signals for the first subscriber using the transmit circuit 320 and the first receive circuit 330 to support a voice call for the first subscriber and/or a data transfer for the first subscriber. The transceiver 305 may receive the RF signal for the second subscriber to receive, for example, paging information and/or other information for the second subscriber. As discussed above, the processor 220 may determine the second subscriber has a text message, an alert, and/or an incoming call based on the paging information, and notify the user of the text message, alert, and/or the incoming call via the user interface 250 (shown in FIG. 2). This allows the second subscriber to be paged (i.e., receive paging information) while the transceiver 305 actively transmits and/or receives the RF signals for the first subscriber.

In this example, the transceiver 305 receives data and/or control information for the first subscriber using non-contiguous CA. In the example shown in FIG. 5A, the transceiver 305 receives an RF signal including the first carrier 410 and the second carrier 420 (e.g., via the antenna 310 in FIG. 3). In certain aspects, the first carrier 410 and the second carrier 420 are located in a frequency band (e.g., NR band n66 or another frequency band). For the example where the carriers 410 and 420 are located within the same frequency band, the non-contiguous CA may also be referred as intra-band non-contiguous CA.

The first low-noise amplifier 334 amplifies the RF signal and the first receive mixer 332 mixes the first carrier 410 and the second carrier 420 with the RXLO1 signal. As shown in FIG. 5A, the RXLO1 signal is tuned to a frequency between the first carrier 410 and the second carrier 420. The mixing converts the first carrier 410 into the first downconverted signal and the second carrier 420 into the second downconverted signal. As discussed above, the center frequency of the first downconverted signal is offset from zero frequency by the first offset (labeled “Offset1”) and the center frequency of the second downcoverted signal is offset from zero frequency by the second offset (labeled “Offset2”).

In this example, the first downconverted signal and the second downconverted may be filtered by the first filter 336 (e.g., to filter out out-of-band signals) and converted into a digital signal by the first ADC 338 for processing by the processor 220 in the digital domain. In this example, the processor 220 may shift the frequency of the first downconverted signal by the first offset in the digital domain to obtain the first digital baseband signal and shift the frequency of the second downconverted signal by the second offset in the digital domain to obtain the second digital baseband signal. Thus, the processor 220 may remove the first offset and the second offset in the digital domain. The processor 220 may then process the digital baseband signals (e.g., demodulation, decoding, etc.) to recover the data and/or control information for the first subscriber.

Using the RXLO1 signal to frequency downconvert both the first carrier 410 and the second carrier 420 allows the transceiver 305 to receive data and/or control information for the first subscriber using non-contiguous CA while receiving paging information and/or other information for the second subscriber (e.g., in the DSDS mode).

In the example shown in FIG. 5A, the second receive circuit 340 receives the paging information and/or other information for the second subscriber via an RF signal including a carrier 510. The carrier 510 may also be referred to as the third carrier to distinguish the carrier 510 from the first carrier 410 and the second carrier 420. In this example, the second low-noise amplifier 344 amplifies the RF signal and the second receive mixer 342 mixes the carrier 510 with the RXLO2 signal. As shown in FIG. 5A, the RXLO2 signal may be tuned to a frequency that is approximately aligned with the center frequency of the carrier 510. The mixing converts the carrier 510 to a third downconverted signal. In certain aspects, the third downconverted signal is a baseband signal, but is not limited to this example.

In this example, the second filter 346 passes the third downconverted signal and filters out out-of-band signals. The second ADC 348 converts the third downconverted signal (e.g., baseband signal) into a digital baseband signal for processing by the processor 220 in the digital domain. In this example, the processor 220 processes the digital baseband signal (e.g., demodulation, decoding, etc.) to recover the paging information and/or information for the second subscriber.

FIG. 5B illustrates an example in which the transceiver 305 provides MSIM with non-contiguous CA in the second configuration. As discussed above, in the second configuration, the RXLO2 signal from the second frequency synthesizer 365 (shown in FIG. 3) is input to the first receive mixer 332 and the RXLO1 signal from the first frequency synthesizer 360 (shown in FIG. 3) is input to the second receive mixer 334.

In this example, the transceiver 305 may actively receive and/or transmit the RF signals for the first subscriber using the transmit circuit 320 (shown in FIG. 3) and the first receive circuit 330 while receiving the RF signal for the second subscriber using the second circuit 340 (e.g., in the DSDS mode). As discussed above with reference to FIG. 5A, the transceiver 305 may actively receive and/or transmit the RF signals for the first subscriber to support a voice call for the first subscriber and/or a data transfer for the first subscriber, and the transceiver 305 may receive the RF signal for the second subscriber to receive the paging information and/or other information for the second subscriber.

In this example, the transceiver 305 receives the data and/or control information for the first subscriber using non-contiguous CA in the manner discussed above with reference to FIG. 5A except that the first receive mixer 332 mixes the first carrier 410 and the second carrier 420 with the RXLO2 signal instead of the RXLO1 signal to generate the first downconverted signal and the second downconverted signal. In the example shown in FIG. 5B, the RXLO2 signal is tuned to a frequency between the first carrier 410 and the second carrier 420.

The transceiver 305 also receives the paging information and/or other information for the second subscriber in the manner discussed above with reference to FIG. 5A except that the second receive mixer 342 mixes the carrier 510 with the RXLO1 signal instead of the RXLO2 signal to generate the third downconverted signal (e.g., baseband signal) for the second subscriber. In the example shown in FIG. 5B, the RXLO1 signal is tuned to a frequency approximately aligned with the center frequency of the carrier 510.

As discussed above, the first frequency synthesizer 360 may be configured to provide higher performance than the second frequency synthesizer 365 while the second frequency synthesizer 365 is configured to consume less power than the first frequency synthesizer 360. In this example, the second configuration shown in FIG. 5B may be used to lower power in cases where the RXLO2 signal from the second frequency synthesizer 365 provides sufficient performance to reliably receive the data and/or control information for the first subscriber using non-contiguous CA. The second configuration lowers power since the second frequency synthesizer 365 operates at lower power than the first frequency synthesizer 360.

In the second configuration, the RXLO1 signal from the first frequency synthesizer 360 is used to receive the paging information and/or other information for the second subscriber. Using the RXLO1 signal for the second subscriber may result in a slight increase in power for the second subscriber. However, the slight increase in power may be significantly outweighed by the reduction in power from using the RXLO2 signal for the first subscriber, resulting in a significant overall power reduction. This is because the transceiver 305 may periodically receive a page (e.g., paging message) for the second subscriber where each page has a short duration and the spacing between pages is much longer than the duration of a page. Moreover, the use of the RXLO1 signal for paging reception greatly improves the probability or the success rate of decoding a page. This is due to better signal to noise ratio (SNR) resulting from better integrated phase noise (IPN) performance of the RXLO1 signal.

Thus, the transceiver 305 may opportunistically lower power by operating in the second configuration shown in FIG. 5B in cases where the second frequency synthesizer 365 provides sufficient performance to reliably receive the data and/or control information for the first subscriber using non-contiguous CA. As discussed further below, the controller 390 (shown in FIG. 3) may be configured to operate the transceiver 305 in the second configuration to lower power when one or more conditions are met. Examples of the one or more conditions are provided below.

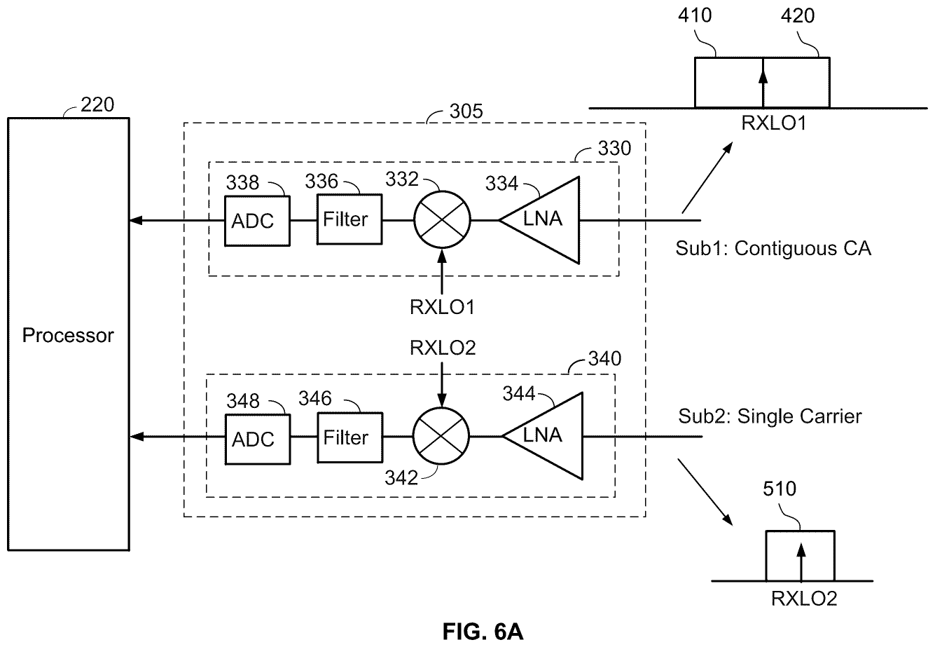

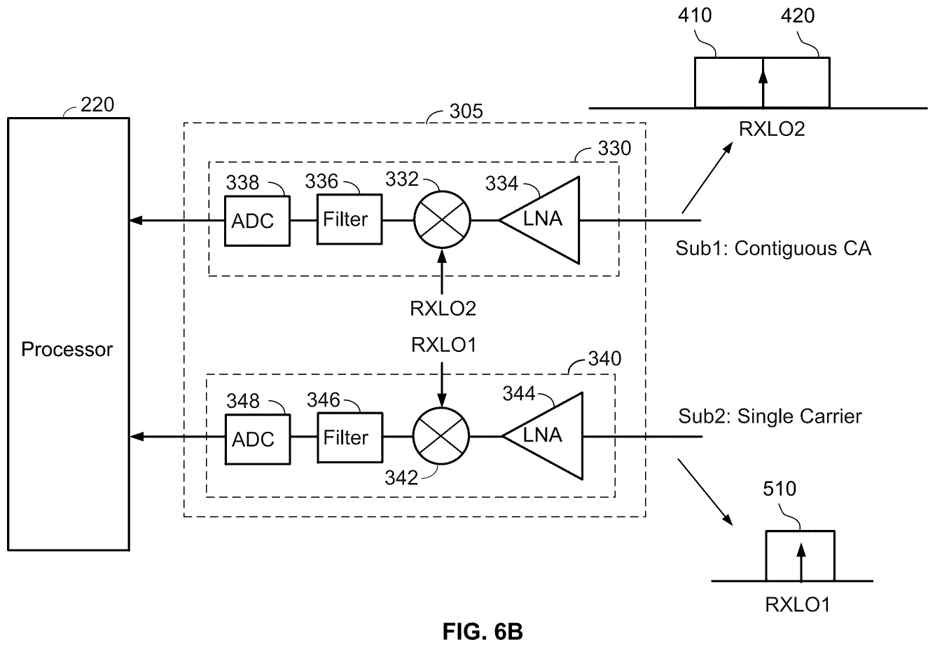

FIG. 6A illustrates an example in which the transceiver 305 provides MSIM with contiguous CA in the first configuration. As discussed above, in the first configuration, the RXLO1 signal from the first frequency synthesizer 360 (shown in FIG. 3) is input to the first receive mixer 332 and the RXLO2 signal from the second frequency synthesizer 365 (shown in FIG. 3) is input to the second receive mixer 334.

In this example, the transceiver 305 may actively receive and/or transmit the RF signals for the first subscriber using the transmit circuit 320 (shown in FIG. 3) and the first receive circuit 330 while receiving the RF signal for the second subscriber using the second circuit 340 (e.g., in the DSDS mode). As discussed above with reference to FIG. 5A, the transceiver 305 may actively receive and/or transmit the RF signals for the first subscriber to support a voice call for the first subscriber and/or a data transfer for the first subscriber, and the transceiver 305 may receive the RF signal for the second subscriber to receive the paging information and/or other information for the second subscriber.

In this example, the transceiver 305 receives the data and/or control information for the first subscriber using contiguous CA in the manner discussed above with reference to FIG. 5A except that the first carrier 410 and the second carrier 420 are located next to one another instead of being spaced apart. As shown in FIG. 6A, the RXLO1 signal is tuned to a frequency between the first carrier 410 and the second carrier 420. The transceiver 305 also receives the paging information and/or other information for the second subscriber in the manner discussed above with reference to FIG. 5A. As shown in FIG. 6A, the RXLO1 signal may be aligned with the center frequency of the carrier 510.

FIG. 6B illustrates an example in which the transceiver 305 provides MSIM with contiguous CA in the second configuration. As discussed above, in the second configuration, the RXLO2 signal from the second frequency synthesizer 365 (shown in FIG. 3) is input to the first receive mixer 332 and the RXLO1 signal from the first frequency synthesizer 360 (shown in FIG. 3) is input to the second receive mixer 334.

In this example, the transceiver 305 may actively receive and/or transmit the RF signals for the first subscriber using the transmit circuit 320 (shown in FIG. 3) and the first receive circuit 330 while receiving the RF signal for the second subscriber using the second circuit 340 (e.g., in the DSDS mode). As discussed above with reference to FIG. 5A, the transceiver 305 may actively receive and/or transmit the RF signals for the first subscriber to support a voice call for the first subscriber and/or a data transfer for the first subscriber, and the transceiver 305 may receive the RF signal for the second subscriber to receive the paging information and/or other information for the second subscriber.

In this example, the transceiver 305 receives the data and/or control information for the first subscriber using contiguous CA in the manner discussed above with reference to FIG. 5B except that the first carrier 410 and the second carrier 420 are spaced next to one another instead of being spaced apart. In the example shown in FIG. 6B, the RXLO2 signal is tuned to a frequency between the first carrier 410 and the second carrier 420.

The transceiver 305 also receives the paging information and/or other information for the second subscriber in the manner discussed above with reference to FIG. 5B in which the second receive mixer 342 mixes the carrier 510 with the RXLO1 signal instead of the RXLO2 signal to generate the third downconverted signal (e.g., baseband signal) for the second subscriber. In the example shown in FIG. 6B, the RXLO1 signal is tuned to a frequency approximately aligned with the center frequency of the carrier 510.

As discussed above with reference to FIG. 5B, operating the transceiver in the second configuration lowers overall power compared with the first configuration. As a result, the transceiver 305 may opportunistically lower power by operating in the second configuration shown in FIG. 6B in cases where the second frequency synthesizer 365 provides sufficient performance to reliably receive the data and/or control information for the first subscriber using contiguous CA.

In certain aspects, the wireless device 130 receives a downlink (DL) grant from a base station (e.g., the first base station 110 or the second base station 120) indicating a modulation coding scheme (MCS) assigned to the first carrier 410 and/or the second carrier 420 for data and/or control information reception. The assigned MCS may be indicated by a numerical index. For example, the MCS for the first subscriber may be selected from a group of MCSs including MCS1, MCS2, MCS3, and so forth where each of the MCSs corresponds to a respective modulation scheme and coding rate. The modulation scheme for each of the MCSs may be chosen from a group of modulation schemes including, for example, binary phase shift keying (BPSK), quadrature phase shift keying (QPSK), 16 quadrature amplitude modulation (16 QAM), 64 QAM, 256 QAM, and the like. It is to be appreciated that two or more of the MCSs may use the same modulation scheme but with different coding rates. Each of the MCSs may have a respective minimum signal-to-noise ratio (SNR) requirement and/or a respective minimum received signal strength indicator (RSSI).

In this example, the controller 390 may be configured to switch the transceiver 305 from the first configuration to the second configuration to lower power based on the MCS in the DL grant. For example, the controller 390 may be configured to operate the transceiver 305 in the second configuration to lower power when the MCS in the DL grant is in a first set of MCSs and operate the transceiver 305 in the first configuration when the MCS in the DL grant is in a second set of MCSs. The first set of MCSs and the second set of MCSs may be included in the group of MCSs discussed above. In this example, the MCSs in the first set of MCSs may correspond to MCSs with lower minimum SNR requirements and/or lower RSSI requirements compared with the MCSs in the second set of MCSs. The lower minimum SNR requirements and/or lower RSSI requirements for the MCSs in the first set of MCSs allow the data and/or control information for the first subscriber to be received with a lower power mode (LPM) frequency synthesizer (e.g., the second frequency synthesizer 365).

In certain aspects, the MCS in the first set of MCSs may have a lower numerical index than the MCS in the second set of MCSs. In this example, the controller 390 may operate the transceiver 305 in the second configuration when the MCS in the DL grant is below a MCS threshold and operate the transceiver 305 in the first configuration when the MCS in the DL grant is equal to or above the MCS threshold. In this example, the MCS threshold may correspond to a threshold MCS index, in which the MCSs below the MCS threshold have an MCS index below the threshold MCS index and MCSs above the MCS threshold have an MCS index above the threshold MCS index.

In certain aspects, the wireless device 130 may receive separate grants for the first carrier 410 and the second carrier 420 from the base station (e.g., the first base station 110 or the second base station 120). In these aspects, the grants may include a first MCS for the first carrier 410 and a second MCS for the second carrier. The first MCS and the second MCS may be the same or different (e.g., depending on the traffic on the first carrier 410 and the traffic on the second carrier 420). In this example, the controller 390 may operate the transceiver 305 in the first configuration when one or both of the first MCS and the second MCS are in the second set of MCSs (e.g., above the MCS threshold). The controller 390 may operate the transceiver 305 in the second configuration to lower power when both of the first MCS and the second MCS are in the first set of MCSs (e.g., below the MCS threshold).

Thus, in this example, the controller 390 may opportunistically lower power by operating the transceiver 305 in the second configuration (shown in FIGS. 5B and 6B) when the first MCS and the second MCS are in the first set of MCSs (e.g., below the MCS threshold). However, it is to be appreciated that the present disclosure is not limited to this example.

For example, in some implementations, the controller 390 may switch to the second configuration when one or more conditions are met. The one or more conditions may be in addition to the first MCS and the second MCS being in the first set of MCSs (e.g., below the MCS threshold). However, it is to be appreciated that the present disclosure is not limited to this example.

Examples of conditions for switching to the second configuration may include one or more of the following. A first condition may be that SNR_{LPM} >SNR threshold for physical downlink control channel (PDCCH) decoding for the first carrier 410 and the second carrier 420, wherein SNR_{LPM} is the SNR of a receive circuit while using the RXLO2 signal.

A second condition may be that receive (RX) reciprocal mixing results in a <XdB SNR impact on both the first carrier 410 and the second carrier 420, wherein XdB may be a small value (e.g., 0.1 dB). A third condition may be that transmit (TX) reciprocal mixing results in a <XdB SNR impact on both the first carrier 410 and the second carrier 420.

A fourth condition may be that no jammers are detected on both the first carrier 410 and the second carrier 420. For example, the wireless device 130 may accumulate the energy within a frequency range over a period of time and compare the accumulated energy with a threshold to detect the presence or absence of the jammer. In this example, the wireless device 130 may detect the presence of the jammer when the accumulated energy is equal to or above the threshold and detect the absence of the hammer when the accumulated energy is below the threshold.

A fifth condition may be that the RSSI of both the first carrier 410 and the second carrier 420 be above a certain threshold. For example, the threshold may be defined by a certain amount (e.g., 14 dB) above the reference sensitivity of the receive circuit 330 or the receive circuit 340 mandated by a standard (e.g., the 3GPP standard). However, it is to be appreciated that the threshold is not limited to this example.

A sixth condition may be that one of the following three conditions is satisfied: 1) both the first carrier 410 and the second carrier 420 (e.g., PCC and SCC) are in the physical downlink shared channel (PDSCH) and a moving average of the MCSs for both the first carrier 410 and the second carrier 420 is below the MCS threshold, 2) the first carrier 410 (e.g., PCC) is in the PDSCH, the second carrier 420 (e.g., SCC) is in PDCCH only traffic, and a moving average of the MCS for the first carrier 410 is below the MCS threshold, and 3) both the first carrier 410 and the second carrier 420 are in PDCCH only traffic. In this example, the PDSCH may be used for receiving data traffic and the PDCCH may be used for receiving control information (e.g., resource assignments for uplink and/or downlink data traffic, power control, and the like).

In certain aspects, the controller 390 may switch to the second configuration to lower power when one of the three conditions for the sixth condition is satisfied along with all of the first through fifth conditions being satisfied. In these implementations, the controller 390 may switch to the first configuration when none of the three conditions for the sixth condition are satisfied or any one of the first through fifth conditions is not satisfied. In other implementations, the controller 390 may only require that a subset of the above exemplary conditions be satisfied to switch to the second configuration. In these implementations, the controller 390 may switch to the first configuration when any one of the conditions in the subset is not satisfied.

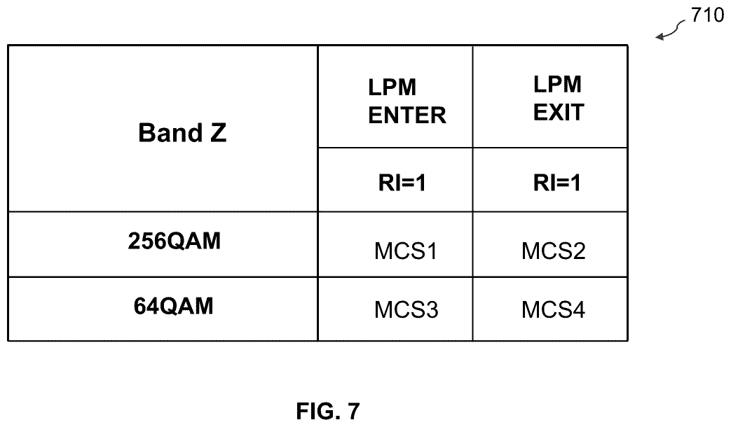

In certain aspects, for a particular frequency band and MCS, the controller 390 may switch to the second configuration or switch to the first configuration based on the MCS of the decoded data for the first subscriber and MCS thresholds for entering and existing the LPM. In this regard, FIG. 7 shows an exemplary table 710 including MCS thresholds for entering the LPM (e.g., switching to the second configuration) and exiting the LPM (e.g., switching to the first configuration) for a frequency band (referred to as band Z) and a rank indicator (RI) of one. The band Z may be any frequency band.

In the example shown in FIG. 7, for the band Z and 256 QAM, the table 710 includes an MCS threshold of MCS1 for entering the LPM (e.g., switching to the second configuration) and an MCS threshold of MCS2 for exiting the LPM (e.g., switching to the first configuration). In this example, when the band Z and 256 QAM are being used for receiving data and/or control information of the first subscriber, the controller 390 enters the LPM when the MCS is equal to or less than MCS1 and exits the LPM when the MCS is equal to or greater than MCS2 based on the table 710. Also, for the band Z and 64 QAM, the table 710 includes an MCS threshold of MCS3 for entering the LPM (e.g., switching to the second configuration) and an MCS threshold of MCS4 for exiting the LPM (e.g., switching to the first configuration). In this example, when the band Z and 64 QAM are being used for receiving data and/or control information of the first subscriber, the controller 390 enters the LPM when the MCS is equal to or less than MCS3 and exits the LPM when the MCS is equal to or greater than MCS4 based on the table 710.

It is to be appreciated that the present disclosure is not limited to the exemplary MCS thresholds and frequency band shown in the table 710, and that other MCS thresholds and/or frequency bands may be used in other examples.

In certain aspects, an MCS comparison with an MCS threshold is used for carriers in the physical downlink shared channel (PDSCH). Thus, in these aspects, the table 710 applies to carriers in the PDSCH. For a carrier in the PDCCH, the SNR for the carrier (e.g., SNR_{LPM}) in the PDCCH may be compared with the SNR threshold needed to decode the PDCCH.

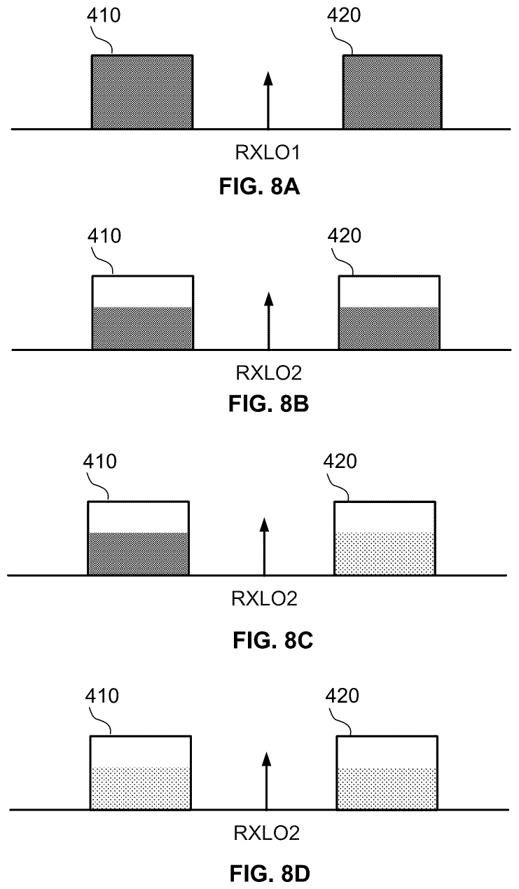

FIG. 8A to 8D illustrate examples of different scenarios in which both the first carrier 410 (e.g., PCC) and the second carrier 420 (e.g., SCC) are active.

FIG. 8A illustrates a scenario in which the wireless device 130 receives a full grant for both the first carrier 410 and the second carrier 420. For example, the full grant may correspond to a DL grant assigning PDSCH MCSs for the first carrier 410 and the second carrier 420 that are above the MCS threshold. In this example, the controller 390 operates the transceiver 305 in the first configuration in which the RXLO1 signal is input to the first receive mixer 332 to frequency downconvert the first carrier 410 and the second carrier 420. As shown in FIG. 8A, the RXLO1 signal is located between the first carrier 410 and the second carrier 420. The dark shading in FIG. 8A indicates that the first carrier 410 and the second carrier 420 are in the PDSCH. In certain aspects, the first carrier 410 is the PCC and the second carrier 420 is the SCC in which the SCC may be activated when the first subscriber needs higher DL throughput.

FIG. 8B illustrates a scenario in which the PDSCH MCSs for the first carrier 410 and the second carrier 420 are below the MCS threshold. This may occur, for example, when the data traffic for the first subscriber is reduced. In this case, the controller 390 operates the transceiver 305 in the second configuration to lower the power in which the RXLO2 signal is input to the first receive mixer 332 to frequency downconvert the first carrier 410 and the second carrier 420. As shown in FIG. 8B, the RXLO2 signal is located between the first carrier 410 and the second carrier 420. In FIG. 8B, the dark shading in each of the carriers 410 and 420 is half filled to indicate the lower MCSs and lower throughput compared with FIG. 8A.

FIG. 8C illustrates a scenario in which the PDSCH MCS for the first carrier 410 is below the MCS threshold and the second carrier 420 is in PDCCH only traffic. In this case, the controller 390 operates the transceiver 305 in the second configuration to lower the power in which the RXLO2 signal is input to the first receive mixer 332 to frequency downconvert the first carrier 410 and the second carrier 420. In FIG. 8B, the light shading in the second carrier 420 indicates that the second carrier 420 is in the PDCCH.

FIG. 8D illustrates a scenario in which both the first carrier 410 and the second carrier 420 are in PDCCH only traffic. In this case, the controller 390 operates the transceiver 305 in the second configuration to lower the power in which the RXLO2 signal is input to the first receive mixer 332 to frequency downconvert the first carrier 410 and the second carrier 420. In certain aspects, PDCCH only traffic is modulated using QPSK. Since the modulation is limited to QPSK, the throughput is limited and hence the SNR requirement is lower, which can be met by the second frequency synthesizer 365.

The exemplary scenarios illustrated in FIGS. 8A to 8D are shown for the example of non-contiguous CA in which the first carrier 410 and the second carrier 420 are spaced apart in frequency. However, it is to be appreciated that the exemplary scenarios illustrated in FIGS. 8A and 8D are equally applicable to contiguous CA.

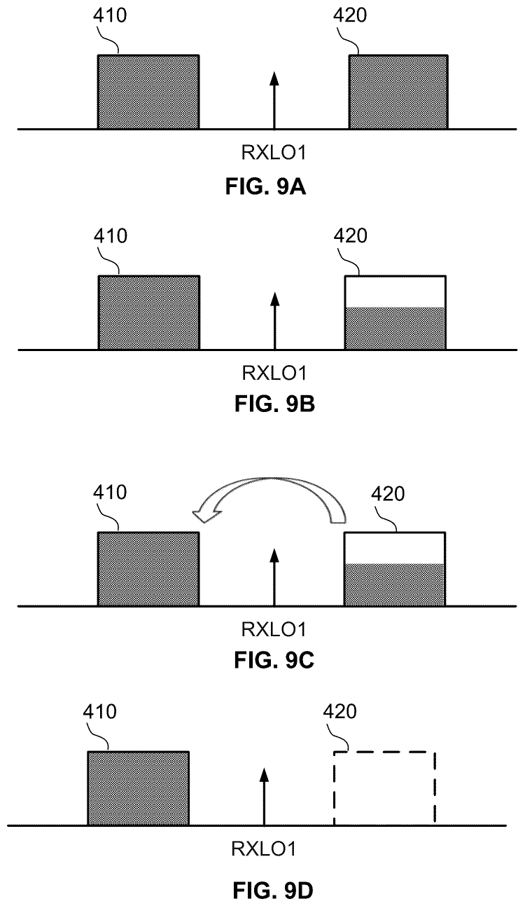

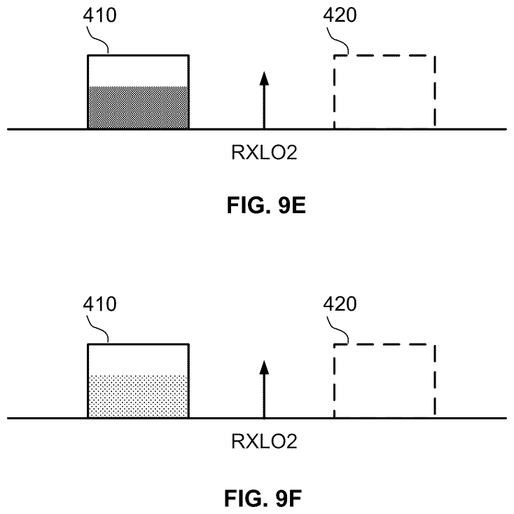

FIG. 9A to 9C illustrate examples of different scenarios in which both the first carrier 410 (e.g., PCC) and the second carrier 420 (e.g., SCC) are active, and FIG. 9D to 9F illustrate examples of different scenarios in which the first carrier 410 (e.g., PCC) is active and the second carrier 420 (e.g., SCC) is deactivated according to certain aspects.

FIG. 9A illustrates an example of a full grant for both the first carrier 410 and the second carrier 420 similar to the scenario illustrated in FIG. 8A. As discussed above, the full grant may correspond to a DL grant assigning PDSCH MCSs for the first carrier 410 and the second carrier 420 that are above the MCS threshold. In this example, the controller 390 operates the transceiver 305 in the first configuration in which the RXLO1 signal is input to the first receive mixer 332 to frequency downconvert the first carrier 410 and the second carrier 420. As shown in FIG. 9A, the RXLO1 signal is located between the first carrier 410 and the second carrier 420.

FIG. 9B illustrates a scenario in which the grant for the second carrier 420 is significantly reduced according to certain aspects. The reduced grant for the second carrier 420 may correspond to a DL grant assigning a PDSCH MCS for the second carrier 420 that is below the MCS threshold. In this case, the controller 390 keeps the transceiver 305 in the first configuration since the grant for the first carrier 410 may still be full. In FIG. 9B, the dark shading in the second carrier 420 is half filled to indicate the lower MCS and lower throughput compared with FIG. 9A.

FIG. 9C illustrates a scenario in which the network (e.g., the network associated with the first base station 110 or the second base station 120) reallocates the grant for the second carrier 420 to the first carrier 410. As a result, data traffic on the second carrier 420 is moved to the first carrier 410.

FIG. 9D illustrates a scenario in which the second carrier 420 is deactivated in response to the grant for the second carrier 420 being reallocated to the first carrier 410. In FIG. 9D, the second carrier 420 is shown in dashed line to indicate that the second carrier 420 is deactivated. In the example shown in FIG. 9D, the frequency of the RXLO1 signal is not changed in response to the deactivation of the second carrier 420. As a result, the first downconverted signal maintains the first offset between the center frequency of the first carrier 410 and the RXLO1 signal. In this example, the processor 220 may shift the frequency of the first downconverted signal by the first offset in the digital domain to remove the first offset, as discussed above. Leaving frequency of the RXLO1 signal unchanged avoids any traffic interruption on the first carrier 410 that may result from retuning the frequency of the RXLO1 signal to the middle of the first carrier 410 while traffic is being received on the first carrier 410.

FIG. 9E illustrates a scenario in which the grant for the first carrier is reduced causing the PDSCH MCS for the first carrier 410 to fall below the MCS threshold. This may occur, for example, when the data traffic for the first subscriber is reduced. In this case, the controller 390 operates the transceiver 305 in the second configuration to lower the power in which the RXLO2 signal is input to the first receive mixer 332 to frequency downconvert the first carrier 410. In the example shown in FIG. 9E, the frequency of the RXLO2 signal is set between the first carrier 410 and the second carrier 420. As a result, the first downconverted signal maintains the first offset between the center frequency of the first carrier 410 and the RXLO2 signal. In this example, the processor 220 may shift the frequency of the first downconverted signal by the first offset in the digital domain to remove the first offset, as discussed above.

FIG. 9F illustrates a scenario in which the first carrier 410 is in PDCCH only traffic. In this case, the controller 390 operates the transceiver 305 in the second configuration to lower the power with the RXLO2 signal offset from the center frequency of the first carrier 410, as discussed above.

The exemplary scenarios illustrated in FIGS. 9A to 9F are shown for the example of non-contiguous CA in which the first carrier 410 and the second carrier 420 are spaced apart in frequency. However, it is to be appreciated that the exemplary scenarios illustrated in FIGS. 9A and 9F are equally applicable to contiguous CA.

In some implementations, for the case where the first carrier 410 (e.g., PCC) is active and the second carrier 420 (e.g., SCC) is deactivated, the controller 390 may switch to the second configuration when one or more conditions are met. The one or more conditions may be in addition to the MCS for the first carrier 410 being in the first set of MCSs (e.g., below the MCS threshold). However, it is to be appreciated that the present disclosure is not limited to this example.

Examples of conditions for switching to the second configuration may include one or more of the following. A first condition may be that SNR_{LPM}>SNR threshold for PDCCH decoding for the first carrier 410, wherein SNR_{LPM} is the SNR of a receive circuit while using the RXLO2 signal.

A second condition may be that the RX reciprocal mixing results in a <XdB SNR impact on the first carrier 410, wherein XdB may be a small value (e.g., 0.1 dB). A third condition may be that the transmit TX reciprocal mixing results in a <XdB SNR impact on the first carrier 410.

A fourth condition may be that no jammers be detected on the first carrier 410. For example, the wireless device 130 may accumulate the energy within a frequency range over a period of time and compare the accumulated energy with a threshold to detect the presence or absence of the jammer, as discussed above.

A fifth condition may be that the RSSI of the first carrier 410 be above a certain threshold. For example, the threshold may be defined by a certain amount (e.g., 14 dB) above the reference sensitivity of the receive circuit 330 or the receive circuit 340 mandated by a standard (e.g., the 3GPP standard). However, it is to be appreciated that the threshold is not limited to this example.

A sixth condition may be that one of the following two conditions is satisfied: 1) the first carrier 410 is in the PDSCH and a moving average of the MCS for the first carrier 410 is below the MCS threshold and 2) the first carrier 410 is in PDCCH only traffic.

In certain aspects, the controller 390 may switch to the second configuration to lower power when one of the two conditions for the sixth condition is satisfied along with all of the first through fifth conditions being satisfied. In these implementations, the controller 390 may switch to the first configuration when none of the two conditions for the sixth condition are satisfied or any one of the first through fifth conditions is not satisfied. In other implementations, the controller 390 may only require that a subset of the above exemplary conditions be satisfied to switch to the second configuration. In these implementations, the controller 390 may switch to the first configuration when any one of the conditions in the subset is not satisfied.

The transceiver 305 is discussed above according to certain aspects using the example of the DSDS mode in which the transceiver 305 may actively receive and/or transmit RF signals for the first subscriber using the transmit circuit 320 and the first receive circuit 330 while receiving an RF signal for the second subscriber using the second circuit 340. However, it is to be appreciated that aspects of the present disclosure are not limited to the DSDS mode.

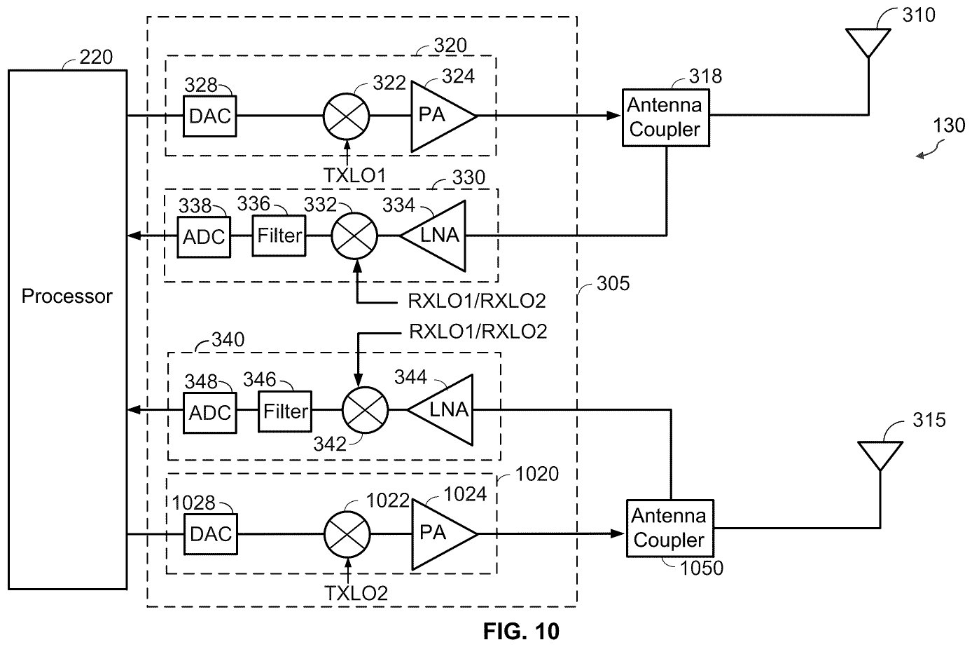

In this regard, FIG. 10 shows an example in which the transceiver 305 further includes a second transmit circuit 1020 to support the DSDA mode. The second transmit circuit 1020 allows the transceiver 305 to also actively receive and/or transmit RF signals for the second subscriber using the second receive circuit 340 and the second transmit circuit 1020 in the DSDA mode.

In the example in FIG. 10, the wireless device 130 includes a second antenna coupler 1050. In this example, the second transmit circuit 1020 and the second receive circuit 340 are coupled are the second antenna 315 though the second antenna coupler 1050. The second antenna coupler 1050 may include a switch, a duplexer, or the like.

The second transmit circuit 1020 includes a second DAC 1028, a second transmit mixer 1022, and a second power amplifier 1024. The second DAC 1028 may be configured to convert a digital baseband signal from the processor 220 into an analog baseband signal. The second transmit mixer 1022 may be configured to mix the baseband from the second DAC 1028 with a second transmit local oscillator (TXLO2) signal to frequency upconvert the baseband signal into a transmit RF signal. The second power amplifier 1024 is configured to amplify the transmit RF signal, and output the amplified RF signal for transmission via the second antenna 315. In this example, the RF signal output by the second transmit circuit 1020 may be for the second subscriber.

The second receive circuit 340 may receive an RF signal for the second subscriber using a single carrier or contiguous CA or non-contiguous CA using any one of the exemplary methodologies discussed above for the first receive circuit 330. For example, the second receive circuit 340 may frequency downconvert two carriers in the RF into downconverted signals using the RXLO1 signal or the RXLO2 signal, in which the RXLO1 signal or the RXLO2 signal is located between the carriers and each of the downconverted signals is offset from zero frequency. In this example, the processor 220 may later remove the offsets in the digital domain, as discussed above.

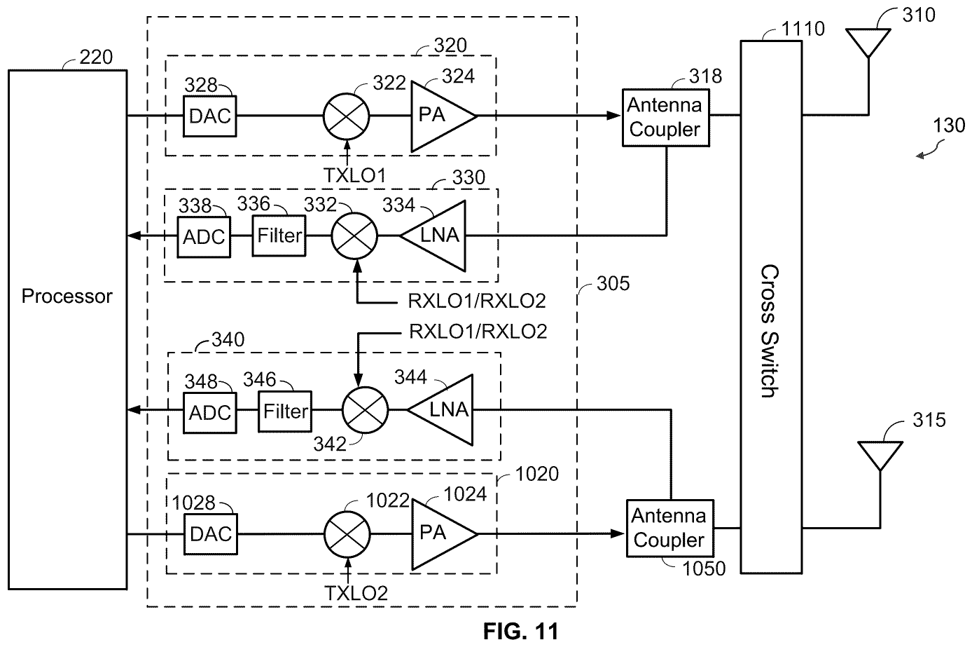

FIG. 11 shows an example in which the wireless device 130 further includes a cross switch 1110 between the antenna couplers 318 and 1050 and the antennas 310 and 315. In this example, the cross switch 1110 is configured to selectively couple the antenna coupler 318 to the first antenna 310 or the second antenna 315, and selectively couple the antenna coupler 1050 to the second antenna 315 or the first antenna 310. This allows the first transmit circuit 320 and the first receive circuit 330 to swap antennas with the second transmit circuit 1020 and the second receive circuit 340.

As discussed above, in the DSDS mode, the wireless device 130 may actively transmit and receive RF signals to support a call and/or data session (e.g., data call) for the first subscriber while receiving paging information for the second subscriber. In this example, the wireless device 130 may receive an RF signal for the first subscriber from a base station (e.g., base station 110 or 120). When the wireless device 130 moves away from the base station, the SNR is reduced as the RF signal received by the wireless device 130 becomes weaker. As a result, the throughput of the receiver may drop significantly. In addition, higher transmit power may be needed to transmit an RF signal to the base station. This leads to higher power consumption due to higher transmit requirement and poor connectivity.

In this scenario, the wireless device 130 may switch the call and/or data session from the first subscriber to the second subscriber (e.g., in cases where better connectivity can be achieved by switching to the second subscriber). Existing solutions use received signal strength indicator (RSSI) to determine whether to switch subscribers (i.e., SIMs 255 and 260) for a call and/data session. Aspects of the present disclosure use channel quality indicator (CQI) for assured throughput enhancement, as discussed further below.

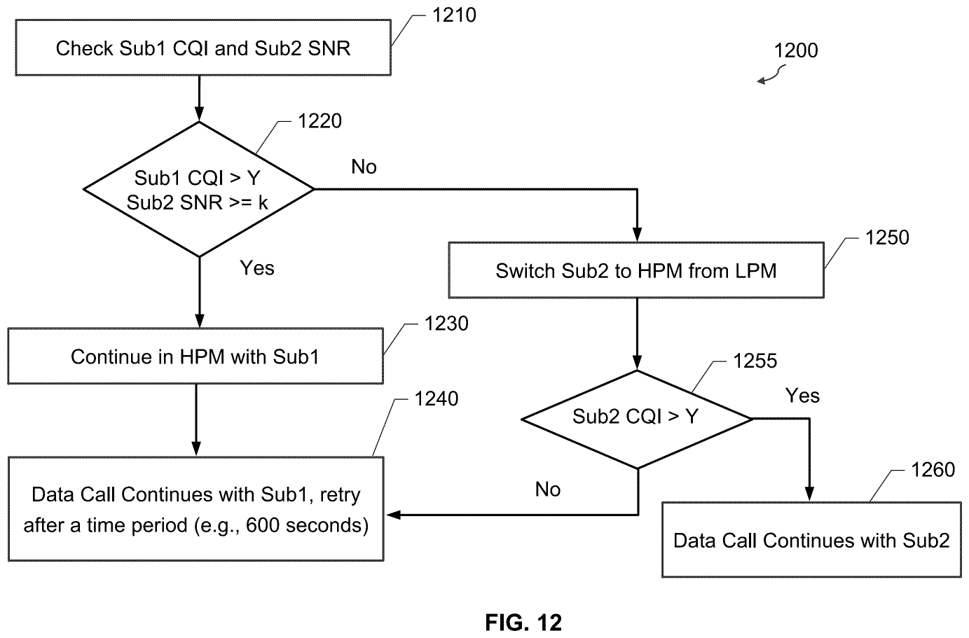

FIG. 12 is a flowchart illustrating an exemplary method 1200 for switching a data call between subscribers (i.e., SIMs 255 and 260) according to certain aspects. The method 1200 may be performed by the processor 220 and/or the controller 390. The method 1200 is discussed first for the case in which no jammer is present for the second subscriber. The case in which a jammer is present for the second subscriber is discussed later.

The SIMs 255 and 260 associated with the first and second subscribers, respectively, may correspond to two different network carriers. However, the present disclosure is not limited to this example.

Initially, the first subscriber is active on a data call and the second subscriber is on paging. For example, the wireless device 130 may actively transmit and receive RF signals for the data call using the transmit circuit 320 and the first receive circuit 330 while receiving an RF signal with paging information for the second subscriber using the second receive circuit 340. The wireless device 130 may use non-contiguous or contiguous carrier aggregation to receive the RF signal for the first subscriber, as discussed above. In this example, the high-performance mode (HPM) is used for the first subscriber in which the RXLO1 signal from the first frequency synthesizer 360 is used to downconvert the RF signal for the first subscriber. The low power mode (LPM) is used for the second subscriber in which the RXLO2 signal from the second frequency synthesizer 365 is used to downconvert the RF signal with the paging information for the second subscriber. In this example, the first frequency synthesizer 360 provides higher performance while the second frequency synthesizer 365 consumes less power, as discussed above.

Referring to FIG. 12, at block 1210, a CQI for the first subscriber and an SNR for the second subscriber are checked (e.g., by the processor 220). For example, the CQI may be a number indicating the quality of the channel between the wireless device 130 and the base station (e.g., base station 110 or 120) supporting the data call. The SNR for the second subscriber may correspond to the SNR of the received RF signal with the paging information for the second subscriber.

At block 1220, the CQI for the first subscriber is compared with a first threshold Y and the SNR for the second subscriber is compared with a second threshold k. For example, the first threshold Y may be used to indicate that the wireless device 130 has moved away from the base station when the CQI drops below the first threshold Y. In this example, a CQI greater than the first threshold Y may indicate that the channel quality is good enough to provide adequate throughput for the data call. In this example, an SNR greater than the second threshold k may indicate that the SNR for the second subscriber is high enough to reliably receive paging information and/or other information for the second subscriber.

If the CQI is greater than the first threshold Y and the SNR is greater than or equal to the second threshold k, then the HPM continues with the first subscriber in block 1230 (i.e., the RXLO1 signal from the first frequency synthesizer 360 is used to downconvert the RF signal for the first subscriber). Also, the data call continues with the first subscriber at block 1240. The method 1200 may recheck the CQI for the first subscriber and the SNR for the second subscriber after a time period (e.g., 600 second) has elapsed. The time period may be used to avoid a ping-pong and tune away penalty caused by repeated switching between subscribers in a short amount of time. The HPM and data call may also continue with the first subscriber if the SNR is less than the second threshold k and the CQI is either greater than or less than the first threshold Y.

If the CQI is equal to or less than the first threshold Y and the SNR is greater than or equal to the second threshold k, then the HPM is switched to the second subscriber and the LPM is switched to the first subscriber. In this case, the RXLO1 signal from the first frequency synthesizer 360 is used to downconvert the RF signal for the second subscriber and the RXLO2 signal from the second frequency synthesizer 365 is used to downconvert the RF signal for the first subscriber. In one example, the first and second subscribers switch receive circuits 330 and 340 such that the first receive circuit 330 is used to receive the RF signal for the second subscriber and the second receive circuit 340 is used to receive the RF signal for the first subscriber. In this example, the multiplexer 370 and 380 do not need to change the routing of the RXLO1 and RXLO2 signals. In another example, the first receive circuit 330 is used to receive the RF signal for the first subscriber and the second receive circuit 340 is used to receive the RF signal for the second subscriber. In this example, the multiplexers 370 and 380 change the routing of the RXLO1 and RXLO2 signals in which the RXLO1 signal is rerouted to the mixer 342 of the second receive circuit 340 and the RXLO2 signal is rerouted to the mixer 332 of the first receive circuit 330. The transmit circuit 320 may be used to transmit the RF signal for the second subscriber. In this case, the transmit power of the transmit circuit 320 may be adjusted based on the transmit requirements for the second subscriber.

At block 1255, after the switch of the second subscriber to the HPM, the CQI for the second subscriber is compared with the first threshold Y. If the CQI for the second subscriber is greater than the first threshold Y, then the data call continues with the second subscriber at block 1260. In this case, the first subscriber may be in standby in which the wireless device 130 receives paging information and/or other information for the first subscriber. The wireless device 130 may use non-contiguous or contiguous carrier aggregation to receive the RF signal for the second subscriber, as discussed above.

If the CQI for the second subscriber is equal to or less than the first threshold Y, then the data call continues with the first subscriber at block 1240 discussed above. In this case, the HPM is switched back to the first subscriber.

It is to be appreciated that the present disclosure is not limited to using the SNR for the second subscriber in the exemplary method 1200. For example, in another example, the received signal strength indicator (RSSI) for the second subscriber may be used in place of the SNR in the method 1200.

The method 1200 is discussed first for the case of no jammer for the second subscriber (e.g., jammer considered absent when jammer below a threshold) according to certain aspects. For the case of a jammer present for the second subscriber, block 1220 may be modified to compare the SNR of the jammer for the second subscriber with a third threshold k_Jam. The wireless device 130 may detect the jammer, for example, by accumulating the energy within a frequency range over a period of time and comparing the accumulated energy with a threshold to detect the presence or absence of the jammer, as discussed above.

In this example, the processor 220 and/or controller 390 compares the CQI for the first subscriber with the first threshold Y and the SNR of the jammer for the second subscriber with the third threshold k_Jam. If the CQI for the first subscriber is greater than Y and the SNR of the jammer for the second subscriber is greater than the third threshold k_Jam (i.e., sub1 CQI>Y and SNR>k_Jam), then the method 1200 may proceed to block 1230 and continue with HPM for the first subscriber and LPM for the second subscriber. If the CQI for the first subscriber is less than or equal to Y and the SNR of the jammer for the second subscriber is less than or equal to the third threshold k_Jam (i.e., sub1 CQI<=Y and SNR<=k_Jam), then the method 1200 proceeds to block 1250 and switch to HPM for the second subscriber and LPM for the first subscriber.

If the CQI for the first subscriber is less than or equal to Y and the SNR of the jammer for the second subscriber is greater than the third threshold k_Jam (i.e., sub1 CQI<=Y and SNR>k_Jam), then the method 1200 may proceed to block 1230 and continue with HPM for the first subscriber and LPM for the second subscriber. If the CQI for the first subscriber is greater than or equal to Y and the SNR of the jammer for the second subscriber is less than or equal to the third threshold k_Jam (i.e., sub1 CQI>Y and SNR<=k_Jam), then the method 1200 may proceed to block 1250 and switch to HPM for the second subscriber and LPM for the first subscriber.

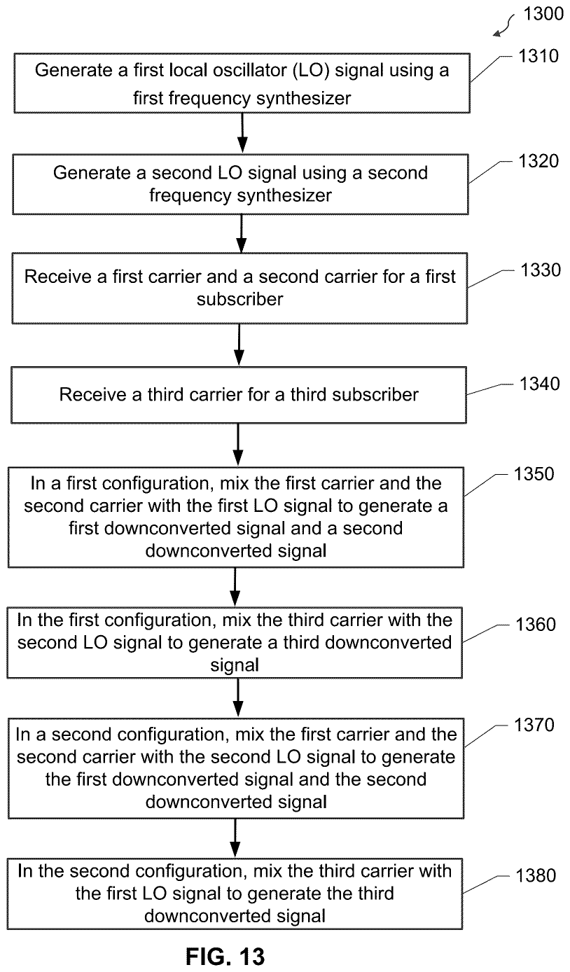

FIG. 13 shows an exemplary method 1300 for wireless communications according to certain aspects.

At block 1310, a first local oscillator (LO) signal is generated using a first frequency synthesizer. For example, the first LO signal may correspond to the RXLO1 signal and the first frequency synthesizer may correspond to the first frequency synthesizer 360.

At block 1320, a second LO signal is generated using a second frequency synthesizer. For example, the second LO signal may correspond to the RXLO2 signal and the second frequency synthesizer may correspond to the second frequency synthesizer 365.

At block 1330, a first carrier and a second carrier are received for a first subscriber. For example, the first carrier and the second carrier may correspond to the first carrier 410 and 420, respectively.

At block 1340, a third carrier is received for a second subscriber. For example, the third carrier may correspond to the carrier 510.

At block 1350, in a first configuration, the first carrier and the second carrier are mixed with the first LO signal to generate a first downconverted signal and a second downconverted signal. For example, the mixing may be performed by the mixer 332.

At block 1360, in the first configuration, the third carrier is mixed with the second LO signal to generate a third downconverted signal. For example, the mixing may be performed by the mixer 342. In the first configuration, the multiplexers 370 and 380 may route the first LO signal to the mixer 322 and route the second LO signal to the mixer 342.

At block 1370, in a second configuration, the first carrier and the second carrier are mixed with the second LO signal to generate the first downconverted signal and the second downconverted signal. For example, the mixing may be performed by the mixer 322.

At block 1380, in the second configuration, the third carrier is mixed with with the first LO signal to generate the third downconverted signal. For example, the mixing may be performed by the mixer 342. In the second configuration, the multiplexers 370 and 380 may route the second LO signal to the mixer 322 and route the first LO signal to the mixer 342.

The method 1300 may also include receiving a first modulation coding scheme (MCS) for the first carrier and a second MCS for the second carrier, and selecting the first configuration or the second configuration based on the first MCS and the second MCS. For example, the receiving and selecting may be performed by the transceiver 230, the processor 220, the controller 390, the first multiplexer 370, and/or the second multiplexer 380.

Implementation examples are described in the following numbered clauses:
1. A system for wireless communications, comprising:
   a first frequency synthesizer configured to generate a first local oscillator (LO) signal;
   a second frequency synthesizer configured to generate a second LO signal;
   a first receive circuit configured to:
      receive a first carrier and a second carrier for a first subscriber; and
      mix the first carrier and the second carrier with the first LO signal or the second LO signal to generate a first downconverted signal and a second downconverted signal;
   a second receive circuit configured to:
      receive a third carrier for a second subscriber; and
      mix the third carrier with the first LO signal or the second LO signal to generate a third downconverted signal;
   a first multiplexer configured to selectively couple the first LO signal or the second LO signal to the first receive circuit; and
   a second multiplexer configured to selectively couple the first LO signal or the second LO signal to the second receive circuit.
2. The system of clause 1, further comprising a controller configured to:
   in a first configuration, cause the first multiplexer to select the first LO signal and cause the second multiplexer to select the second LO; and
   in a second configuration, cause the first multiplexer to select the second LO signal and cause the second multiplexer to select the first LO signal.
3. The system of clause 2, wherein:
   in the first configuration, the first LO signal is located between a center frequency of the first carrier and a center frequency of the second carrier in a frequency domain; and
   in the second configuration, the second LO signal is located between the center frequency of the first carrier and the center frequency of the second carrier in the frequency domain.
4. The system of clause 2 or 3, wherein the first downconverted signal is offset from a zero frequency by a first frequency offset and the second downconverted signal is offset from the zero frequency by a second frequency offset.
5. The system of clause 4, wherein the first receive circuit is configured to convert the first downconverted signal and the second downconverted signal into a first digital downconverted signal and a second digital downconverted signal, respectively, and the system further comprises a processor configured to:
   remove the first frequency offset from the first digital downconverted signal in a digital domain; and
   remove the second frequency offset from the second digital downconverted signal in the digital domain.
6. The system of any one of clauses 2 to 5, wherein the controller is configured to:
   receive a first modulation coding scheme (MCS) for the first carrier and a second MCS for the second carrier; and
   select the first configuration or the second configuration based on the first MCS and the second MCS.
7. The system of clause 6, wherein the first carrier and the second carrier are in a physical downlink shared channel (PDSCH).
8. The system of clause 6 or 7, wherein the controller is configured to select the first configuration if at least one of the first MCS and the second MCS is above a MCS threshold, and select the second configuration if both the first MCS and the second MCS are below the MCS threshold.
9. The system of any one of clauses 6 to 8, wherein the controller is configured to select the first configuration if at least one of the first MCS and the second MCS is above a MCS threshold, and select the second configuration if both the first MCS and the second MCS are below the MCS threshold and the following conditions are satisfied: a signal-to-noise ratio (SNR) of the first carrier and the second carrier downconverted by the second LO signal is above an SNR threshold for physical downlink control channel (PDCCH) decoding for both the first carrier and the second carrier, receive reciprocal mixing results in less than an X dB impact on both the first carrier and the second carrier where X is equal to or less than 0.1, transmit reciprocal mixing results in less than the X dB impact on both the first carrier and the second carrier, no jammer is detected on both the first carrier and the second carrier, and receive signal strength indicator (RSSI) for both the first carrier and the second carrier is above an RSSI threshold.
10. The system of any one of clauses 1 to 9, wherein the first carrier is in a physical downlink shared channel (PDSCH), the second carrier is in a physical downlink control channel (PDCCH) traffic only, and the controller is configured to:
   receive a modulation coding scheme (MCS) for the first carrier; and
   select the first configuration or the second configuration based on the MCS.
11. The system of clause 10, wherein the controller is configured to select the first configuration if the MCS for the first carrier is above a MCS threshold, and select the second configuration if the MCS for the first carrier is below the MCS threshold.
12. The system of clause 10 or 11, wherein the controller is configured to select the first configuration or the second configuration based also on a signal-to-noise (SNR) of the second carrier being below or above an SNR threshold respectively for physical downlink control channel (PDCCH) decoding.
13. The system of any one of clauses 10 to 12, wherein the controller is configured to select the first configuration if the MCS for the first carrier is above a MCS threshold, and select the second configuration if the MCS for the first carrier is below the MCS threshold and the following conditions are satisfied: a signal-to-noise ratio (SNR) of the first carrier and the second carrier downconverted by the second LO signal is above an SNR threshold for physical downlink control channel (PDCCH) decoding for both the first carrier and the second carrier, receive reciprocal mixing results in less than an X dB impact on both the first carrier and the second carrier where X is equal to or less than 0.1, transmit reciprocal mixing results in less than the X dB impact on both the first carrier and the second carrier, no jammer is detected on both the first carrier and the second carrier, and receive signal strength indicator (RSSI) for both the first carrier frequency and the second carrier frequency is above an RSSI threshold.
14. The system of any one of clauses 2 to 13, wherein the controller is configured to select the second configuration if both the first carrier and the second carrier are in a physical downlink control channel (PDCCH).
15. The system of any one of clauses 2 to 14, wherein the controller is configured to:
   receive a modulation coding scheme (MCS) for the first carrier; and
   when the first carrier is active and second carrier is deactivated, select the first configuration or the second configuration based on the MCS for the first carrier.
16. The system of clause 15, wherein the first carrier is in a physical downlink shared channel (PDSCH).
17. The system of clause 15 or 16, wherein the controller is configured to select the first configuration if the MCS is above a MCS threshold, and select the second configuration if the MCS is below the MCS threshold.
18. The system of any one of clauses 15 to 17, wherein the controller is configured to select the first configuration or the second configuration based also on a signal-to-noise ratio (SNR) of the first carrier being below or above an SNR threshold respectively for physical downlink control channel (PDCCH) decoding.
19. The system of any one of clauses 15 to 18, wherein the controller is configured to select the first configuration if the MCS is above a MCS threshold, and select the second configuration if the MCS is below the MCS threshold for the case of PDSCH decoding or select the first configuration or the second configuration if the SNR of the first carrier is below or above the SNR threshold respectively for PDCCH decoding.
20. The system of any one of clauses 15 to 19, wherein the controller is configured to select the first configuration if the MCS is above a MCS threshold, and select the second configuration if both the MCS is below the MCS threshold and the following conditions are satisfied: a signal-to-noise ratio (SNR) of the first carrier down converted by a second LO signal is above an SNR threshold for physical downlink control channel (PDCCH) decoding, receive reciprocal mixing results in less than an X dB impact on the first carrier where X is equal to or less than 0.1, transmit reciprocal mixing results in less than the X dB impact on the first carrier, no jammer is detected on the first carrier, and receive signal strength indicator (RSSI) for the first carrier frequency is above an RSSI threshold.
21. The system of any one of clauses 1 to 20, wherein at least one of the first carrier and the second carrier includes data traffic, and the third carrier includes paging information.
22. The system of any one of clauses 1 to 22, wherein the second frequency synthesizer is configured to operate at lower power than the first frequency synthesizer.
23. A method for wireless communications, comprising:
   generating a first local oscillator (LO) signal using a first frequency synthesizer;
   generating a second LO signal using a second frequency synthesizer;
   receiving a first carrier and a second carrier for a first subscriber;
receiving a third carrier for a second subscriber;
   in a first configuration, mixing the first carrier and the second carrier with the first LO signal to generate a first downconverted signal and a second downconverted signal;
   in the first configuration, mixing the third carrier with the second LO signal to generate a third downconverted signal;
   in a second configuration, mixing the first carrier and the second carrier with the second LO signal to generate the first downconverted signal and the second downconverted signal;
   in the second configuration, mixing the third carrier with the first LO signal to generate the third downconverted signal.
24. The method of clause 23, further comprising:
   in the first configuration, setting a frequency of the first LO signal between a center frequency of the first carrier and a center frequency of the second carrier in a frequency domain; and
   in the second configuration, setting a frequency of the second LO signal between the center frequency of the first carrier and the center frequency of the second carrier in the frequency domain.
25. The method of clause 24, wherein the first downconverted signal is offset from a zero frequency by a first frequency offset and the second downconverted signal is offset from the zero frequency by a second frequency offset.
26. The method of clause 25, further comprising:
   converting the first downconverted signal and the second downconverted signal into a first digital downconverted signal and a second digital downconverted signal, respectively;
   removing the first frequency offset from the first digital downconverted signal in a digital domain; and
   removing the second frequency offset from the second digital downconverted signal in the digital domain.
27. The method of any one of clauses 23 to 26, further comprising:
   receiving a first modulation coding scheme (MCS) for the first carrier and a second MCS for the second carrier; and
   selecting the first configuration or the second configuration based on the first MCS and the second MCS.
28. The method of clause 27, wherein the first carrier and the second carrier are in a physical downlink shared channel (PDSCH).
29. The method of clause 27 or 28, wherein selecting the first configuration or the second configuration comprises:
   selecting the first configuration if at least one of the first MCS and the second MCS is above a MCS threshold; and
   selecting the second configuration if both the first MCS and the second MCS are below the MCS threshold.
30. The method of any one of clauses 27 to 29, wherein selecting the first configuration or the second configuration comprises:
   selecting the first configuration if at least one of the first MCS and the second MCS is above a MCS threshold; and
   selecting the second configuration if both the first MCS and the second MCS are below the MCS threshold and the following conditions are satisfied: a signal-to-noise ratio (SNR) of the first carrier and the second carrier downconverted by the second LO signal is above an SNR threshold for physical downlink control channel (PDCCH) decoding for both the first carrier and the second carrier, receive reciprocal mixing results in less than an X dB impact on both the first carrier and the second carrier where X is equal to or less than 0.1, transmit reciprocal mixing results in less than the X dB impact on both the first carrier and the second carrier, no jammer is detected on both the first carrier and the second carrier, and receive signal strength indicator (RSSI) for both the first carrier and the second carrier is above an RSSI threshold.
31. The method of any one of clauses 23 to 30, wherein the first carrier is in a physical downlink shared channel (PDSCH), the second carrier is in a physical downlink control channel (PDCCH) traffic only, and the method further comprises:
   receiving a modulation coding scheme (MCS) for the first carrier; and
   selecting the first configuration or the second configuration based on the MCS.
32. The method of clause 31, wherein selecting the first configuration or the second configuration comprises:
   selecting the first configuration if the MCS for the first carrier is above a MCS threshold; and
   selecting the second configuration if the MCS for the first carrier is below the MCS threshold.
33. The method of clause 31 or 32, wherein selecting the first configuration or the second configuration comprises selecting the first configuration or the second configuration based also on a signal-to-noise (SNR) of the second carrier being below or above an SNR threshold respectively for physical downlink control channel (PDCCH) decoding.
34. The method of any one of clauses 31 to 33, wherein selecting the first configuration or the second configuration comprises:
   selecting the first configuration if the MCS for the first carrier is above a MCS threshold; and
   selecting the second configuration if the MCS for the first carrier is below the MCS threshold and the following conditions are satisfied: a signal-to-noise ratio (SNR) of the first carrier and the second carrier downconverted by the second LO signal is above an SNR threshold for physical downlink control channel (PDCCH) decoding for both the first carrier and the second carrier, receive reciprocal mixing results in less than an X dB impact on both the first carrier and the second carrier where X is equal to or less than 0.1, transmit reciprocal mixing results in less than the X dB impact on both the first carrier and the second carrier, no jammer is detected on both the first carrier and the second carrier, and receive signal strength indicator (RSSI) for both the first carrier frequency and the second carrier frequency is above an RSSI threshold.
35. The method of any one of clauses 23 to 34, further comprising selecting the second configuration if both the first carrier and the second carrier are in a physical downlink control channel (PDCCH).
36. The method of any one of clauses 23 to 35, further comprising:
   receiving a modulation coding scheme (MCS) for the first carrier; and
   when the first carrier is active and second carrier is deactivated, selecting the first configuration or the second configuration based on the MCS for the first carrier.
37. The method of clause 36, wherein the first carrier is in a physical downlink shared channel (PDSCH).
38. The method of clause 36 or 37, wherein selecting the first configuration or the second configuration comprises:
   selecting the first configuration if the MCS is above a MCS threshold; and
   selecting the second configuration if the MCS is below the MCS threshold.
39. The method of any one of clauses 36 to 38, wherein selecting the first configuration or the second configuration comprises selecting the first configuration or the second configuration based also on a signal-to-noise ratio (SNR) of the first carrier being below or above an SNR threshold respectively for physical downlink control channel (PDCCH) decoding.
40. The method of any one of clauses 36 to 39, wherein selecting the first configuration or the second configuration comprises:
   selecting the first configuration if the MCS is above a MCS threshold; and
   selecting the second configuration if the MCS is below the MCS threshold for the case of PDSCH decoding or selecting the first configuration or the second configuration if the SNR of the first carrier is below or above the SNR threshold respectively for PDCCH decoding.
41. The method of any one of clauses 36 to 40, wherein selecting the first configuration or the second configuration comprises:
   selecting the first configuration if the MCS is above a MCS threshold; and
   selecting the second configuration if both the MCS is below the MCS threshold and the following conditions are satisfied: a signal-to-noise ratio (SNR) of the first carrier down converted by a second LO signal is above an SNR threshold for physical downlink control channel (PDCCH) decoding, receive reciprocal mixing results in less than an X dB impact on the first carrier where X is equal to or less than 0.1, transmit reciprocal mixing results in less than the X dB impact on the first carrier, no jammer is detected on the first carrier, and receive signal strength indicator (RSSI) for the first carrier frequency is above an RSSI threshold.
42. The method of any one of clauses 23 to 41, wherein at least one of the first carrier and the second carrier includes data traffic, and the third carrier includes paging information.
43. The method of any one of clauses 23 to 42, wherein the second frequency synthesizer is configured to operate at lower power than the first frequency synthesizer.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures. It is also to be appreciated that the term “ground” may refer to a DC ground or an AC ground, and thus the term “ground” covers both possibilities. At least one of A and B means, A, B, or both A and B.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A system for wireless communications, comprising:
a first frequency synthesizer configured to generate a first local oscillator (LO) signal;
a second frequency synthesizer configured to generate a second LO signal;
a first receive circuit configured to:
receive a first carrier and a second carrier for a first subscriber; and
mix the first carrier and the second carrier with the first LO signal or the second LO signal to generate a first downconverted signal and a second downconverted signal;
a second receive circuit configured to:
receive a third carrier for a second subscriber; and
mix the third carrier with the first LO signal or the second LO signal to generate a third downconverted signal;
a first multiplexer configured to selectively couple the first LO signal or the second LO signal to the first receive circuit; and
a second multiplexer configured to selectively couple the first LO signal or the second LO signal to the second receive circuit.

2. The system of claim 1, further comprising a controller configured to:
in a first configuration, cause the first multiplexer to select the first LO signal and cause the second multiplexer to select the second LO; and
in a second configuration, cause the first multiplexer to select the second LO signal and cause the second multiplexer to select the first LO signal.

3. The system of claim 2, wherein:
in the first configuration, the first LO signal is located between a center frequency of the first carrier and a center frequency of the second carrier in a frequency domain; and
in the second configuration, the second LO signal is located between the center frequency of the first carrier and the center frequency of the second carrier in the frequency domain.

4. The system of claim 2, wherein the first downconverted signal is offset from a zero frequency by a first frequency offset and the second downconverted signal is offset from the zero frequency by a second frequency offset.

5. The system of claim 4, wherein the first receive circuit is configured to convert the first downconverted signal and the second downconverted signal into a first digital downconverted signal and a second digital downconverted signal, respectively, and the system further comprises a processor configured to:
remove the first frequency offset from the first digital downconverted signal in a digital domain; and
remove the second frequency offset from the second digital downconverted signal in the digital domain.

6. The system of claim 2, wherein the controller is configured to:
receive a first modulation coding scheme (MCS) for the first carrier and a second MCS for the second carrier; and
select the first configuration or the second configuration based on the first MCS and the second MCS.

7. The system of claim 6, wherein the first carrier and the second carrier are in a physical downlink shared channel (PDSCH).

8. The system of claim 6, wherein the controller is configured to select the first configuration if at least one of the first MCS and the second MCS is above a MCS threshold, and select the second configuration if both the first MCS and the second MCS are below the MCS threshold.

9. The system of claim 2, wherein the first carrier is in a physical downlink shared channel (PDSCH), the second carrier is in a physical downlink control channel (PDCCH) traffic only, and the controller is configured to:
receive a modulation coding scheme (MCS) for the first carrier; and
select the first configuration or the second configuration based on the MCS.

10. The system of claim 9, wherein the controller is configured to select the first configuration if the MCS for the first carrier is above a MCS threshold, and select the second configuration if the MCS for the first carrier is below the MCS threshold.

11. The system of claim 9, wherein the controller is configured to select the first configuration or the second configuration based also on a signal-to-noise (SNR) of the second carrier being below or above an SNR threshold respectively for physical downlink control channel (PDCCH) decoding.

12. The system of claim 2, wherein the controller is configured to select the second configuration if both the first carrier and the second carrier are in a physical downlink control channel (PDCCH).

13. The system of claim 2, wherein the controller is configured to:
receive a modulation coding scheme (MCS) for the first carrier; and
when the first carrier is active and second carrier is deactivated, select the first configuration or the second configuration based on the MCS for the first carrier.

14. The system of claim 13, wherein the first carrier is in a physical downlink shared channel (PDSCH).

15. The system of claim 13, wherein the controller is configured to select the first configuration if the MCS is above a MCS threshold, and select the second configuration if the MCS is below the MCS threshold.

16. The system of claim 13, wherein the controller is configured to select the first configuration or the second configuration based also on a signal-to-noise ratio (SNR) of the first carrier being below or above an SNR threshold respectively for physical downlink control channel (PDCCH) decoding.

17. The system of claim 1, wherein at least one of the first carrier and the second carrier includes data traffic, and the third carrier includes paging information.

18. The system of claim 1, wherein the second frequency synthesizer is configured to operate at lower power than the first frequency synthesizer.

19. A method for wireless communications, comprising:
generating a first local oscillator (LO) signal using a first frequency synthesizer;
generating a second LO signal using a second frequency synthesizer;
receiving a first carrier and a second carrier for a first subscriber;
receiving a third carrier for a second subscriber;
in a first configuration, mixing the first carrier and the second carrier with the first LO signal to generate a first downconverted signal and a second downconverted signal;
in the first configuration, mixing the third carrier with the second LO signal to generate a third downconverted signal;
in a second configuration, mixing the first carrier and the second carrier with the second LO signal to generate the first downconverted signal and the second downconverted signal;
in the second configuration, mixing the third carrier with the first LO signal to generate the third downconverted signal.

20. The method of claim 19, further comprising:
receiving a first modulation coding scheme (MCS) for the first carrier and a second MCS for the second carrier; and
selecting the first configuration or the second configuration based on the first MCS and the second MCS.
